(19) United States
(12) Patent Application Publication
(10) Pub. No.: US 2026/0288704 A1
(43) Pub. Date: Sep. 24, 2026

(54) Agent System, Data Processing Apparatus, Data Processing Method, and Data Processing Program

(71) Applicant: Softbank Group Corp., Tokyo (JP)

(72) Inventor: Masayoshi Son, Minato-ku, Tokyo (JP)

(21) Appl. No.: 19/475,401

(22) PCT Filed: Apr. 9, 2024
(86) PCT No.: PCT/JP2024/014441

§ 371 Date: Oct. 14, 2025

(30) Foreign Application Priority Data
Apr. 18, 2023 (JP) 2023-068145
Aug. 23, 2023 (JP) 2023-135426
Aug. 24, 2023 (JP) 2023-136434
Sep. 8, 2023 (JP) 2023-146374
Sep. 8, 2023 (JP) 2023-146380
Sep. 15, 2023 (JP) 2023-150201

(51) Int. Cl. G06F 16/242; G06F 16/2457; G06F 16/248; G06F 40/40

(52) U.S. Cl. CPC G06F 16/243; G06F 16/24575; G06F 16/248; G06F 40/40

(57) ABSTRACT

An agent system includes an emotion determination unit that determines an emotion of a user or an emotion of an agent, and an interaction processing unit that outputs speech content of the agent for interacting with the user in an aspect according to the emotion determined by the emotion determination unit.

### TECHNICAL FIELD

The present disclosure relates to an agent system, a data processing apparatus, a data processing method, and a data processing program.

### BACKGROUND ART

Japanese Patent No. 6053847 discloses a technique for determining an appropriate action of a robot with respect to a state of a user. In the related art of Patent Literature 1, a reaction of a user in a case in which the robot executes a specific action is recognized, and in a case in which an action of the robot with respect to the recognized reaction of the user cannot be determined, the action of the robot is updated by receiving information regarding an action suitable for a recognized state of the user from a server.

Japanese Patent Application Laid-Open (JP-A) No. 2022-180282 discloses a persona chat bot control method executed by at least one processor, the method including a step of receiving user speech, a step of adding the user speech to a prompt including an instruction sentence associated with an explanation about a character of a chat bot, a step of encoding the prompt, and a step of inputting the encoded prompt into a language model to generate chat bot speech that is responsive to the user speech.

### SUMMARY OF INVENTION

### Technical Problem

However, in the related art, there is room for improvement in appropriately responding to user input.

An object of the disclosure is to provide an agent system that understands emotions of a user and the agent system and interacts with the user.

### Solution to Problem

According to a first aspect, an agent system is provided. The agent system includes an emotion determination unit that determines an emotion of a user or an emotion of an agent, and an interaction processing unit that outputs speech content of the agent for interacting with the user in an aspect corresponding to the emotion determined by the emotion determination unit.

An agent system of a second aspect is the agent system of the first aspect, further including a character setting unit that sets a character of the agent that outputs the speech content, in which the interaction processing unit synthesizes vocal sound corresponding to the character set by the character setting unit, and outputs the speech content by using the synthesized vocal sound.

An agent system of a third aspect is the agent system of the first or second aspect, in which the interaction processing unit generates the speech content by using a sentence generation model that generates a sentence that is a response to input text or vocal sound.

An agent system of a fourth aspect is the agent system of the third aspect, further including an interaction history storage unit that stores a history of interactions with the user, in which the interaction processing unit generates the speech content by inputting the history of the interactions stored in the interaction history storage unit and the input text or vocal sound to the sentence generation model.

An agent system of a fifth aspect is the agent system of the fourth aspect, further including an operation execution unit that acquires a command of the agent through an interaction with the user and executes an operation according to the command.

An agent system of a sixth aspect is the agent system of the fifth aspect, in which the operation execution unit executes the operation by using personal information of the user acquired from the history of the interactions stored in the interaction history storage unit.

An agent system of a seventh aspect is the agent system of any one of the first to sixth aspects, further including a user imitation unit that newly creates an imitation agent that imitates the user.

An agent system of an eighth aspect is the agent system of the seventh aspect, in which the imitation agent interacts with another agent instead of the user.

An agent system of a ninth aspect is the agent system of the seventh or eighth aspect, further including an interaction history storage unit that stores a history of interactions with the user, in which the user imitation unit creates an imitation agent that imitates the user by using the history of the interactions stored in the interaction history storage unit.

An agent system according to a tenth aspect is the agent system according to any one of the seventh to ninth aspects, in which the user imitation unit creates an imitation agent that imitates the user by using data of the emotion of the user determined by the emotion determination unit.

An agent system of an eleventh aspect is the agent system of any one of the first to tenth aspects, further including a user imitation unit that newly creates an imitation agent that imitates the user, wherein the imitation agent provides information regarding the user through an interaction with another agent or another user.

An agent system of a twelfth aspect is the agent system of the eleventh aspect, further including a generation unit that generates a record in a case in which the imitation agent and one or a plurality of the other users have a discussion.

An agent system of a thirteenth aspect is the agent system of the eleventh or twelfth aspect, further including an interaction history storage unit that stores a history of interactions with the user, wherein the user imitation unit creates an imitation agent that imitates the user by using the history of the interactions stored in the interaction history storage unit.

An agent system of a fourteenth aspect is the agent system of any one of the eleventh to thirteenth aspects, in which the user imitation unit creates an imitation agent that imitates the user by using data of the emotion of the user determined by the emotion determination unit.

An agent system of a fifteenth aspect is the agent system of any one of the first to fourteenth aspects, in which the user interacts with a plurality of the agents.

An agent system of a sixteenth aspect is the agent system of the fifteenth aspect, further including a character setting unit that sets a character of the agent that outputs interaction content of the agent, in which a plurality of the agents have an interaction and discussion with each other, and the interaction processing unit outputs the interaction content according to a property corresponding to the character set by the character setting unit and an aspect corresponding to the emotion determined by the emotion determination unit.

An agent system of a seventeenth aspect is the agent system of the sixteenth aspect, in which in a case in which the user interacts with a plurality of the agents, the interaction is performed such that another agent supplements the interaction content of one agent.

A data processing apparatus according to an eighteenth aspect includes an acquisition unit that acquires input data indicating a user input, a processing unit that performs specific processing using a generation model that generates information according to the input data, and an output unit that outputs a result of the specific processing to an electronic apparatus, in which the acquisition unit acquires a created sentence that is a sentence created by a first user as the input data, the processing unit inputs a prompt including the created sentence acquired by the acquisition unit, a task that is solvable by content of the created sentence, and an instruction for generating a key point of the created sentence to the generation model as the first prompt to generate a task and a key point corresponding to the first prompt, stores the generated task and key point corresponding to the first prompt in a storage unit in association with the created sentence, inputs a prompt including a search query acquired as the input data by the acquisition unit, and an instruction for inquiring about a search intention of a second user assumed from the search query to the generation model as a second prompt to generate a search intention corresponding to the second prompt, and inputs a prompt including an instruction for inquiring about a list of key points related to the task corresponding to the generated search intention corresponding to the second prompt to the generation model as a third prompt to generate a list of key points corresponding to the third prompt, and the output unit outputs the list of key points corresponding to the third prompt generated by the processing unit to the electronic apparatus, and outputs, in a case in which the acquisition unit acquires the input data indicating an interest of the second user in a predetermined key point in the list of key points, the created sentence related to the predetermined key point to the electronic apparatus.

A data processing apparatus according to a nineteenth aspect is the data processing apparatus according to the eighteenth aspect, in which the processing unit stores the generated task and key point corresponding to the first prompt, the created sentence, and the first user in association with each other in the storage unit, and includes an assignment unit that assigns a reward to the first user who has created the created sentence related to the key point output to the electronic apparatus and the first user who has created the created sentence output to the electronic apparatus.

A data processing apparatus according to a twentieth aspect is the data processing apparatus according to the eighteenth or nineteenth aspect, in which the processing unit fine-tunes the generation model by using a pair of the task and the key point corresponding to the first prompt as learning data.

A data processing apparatus according to a twenty-first aspect is the data processing apparatus according to the nineteenth or twentieth aspect, further including a notification unit that notifies an original user, who is the first user who has created the created sentence first acquired by the acquisition unit among a plurality of created sentences, of presence of a similar created sentence in a case in which a similarity of the plurality of created sentences stored in the storage unit is a predetermined value or more and the first users who have created the plurality of created sentences are different, in which in a case in which the acquisition unit acquires a deletion instruction from the original user as the input data, the processing unit deletes, from the storage unit, the created sentence created by another first user similar to the created sentence created by the original user.

A data processing apparatus according to a twenty-second aspect is the data processing apparatus according to any one of the eighteenth to twenty-first aspects, in which the processing unit inputs a prompt including the search query, a viewing history of the created sentence by the second user, and an instruction for inquiring about the search intention to the generation model as the second prompt, and generates a search intention corresponding to the second prompt.

A data processing apparatus according to a twenty-third aspect is the data processing apparatus according to any one of the eighteenth to twenty-second aspects, in which the acquisition unit acquires user information indicating an attribute of the second user as the input data, and in a case in which an inappropriate key point unsuitable for the attribute of the second user indicated by the user information is included in the list of key points corresponding to the third prompt generated by the processing unit, the output unit outputs a list of key points excluding the inappropriate key point to the electronic apparatus.

A data processing method according to a twenty-fourth aspect is a method of causing a computer to execute processing of acquiring input data indicating a user input, performing specific processing using a generation model that generates information according to the input data, outputting a result of the specific processing to an electronic apparatus, acquiring a created sentence that is a sentence created by a first user as the input data, inputting a prompt including the acquired created sentence, a task that is solvable by content of the created sentence, and an instruction for generating a key point of the created sentence to the generation model as a first prompt to generate a task and a key point corresponding to the first prompt, storing the generated task and key point corresponding to the first prompt in a storage unit in association with the created sentence, inputting a prompt including a search query acquired as the input data, and an instruction for inquiring about a search intention of a second user assumed from the search query to the generation model as a second prompt to generate a search intention corresponding to the second prompt; inputting a prompt including an instruction for inquiring about a list of key points related to the task corresponding to the generated search intention corresponding to the second prompt to the generation model as a third prompt to generate a list of key points corresponding to the third prompt, and outputting the list of key points corresponding to the generated third prompt to the electronic apparatus, and outputting, in a case in which the input data indicating an interest of the second user in a predetermined key point in the list of key points is acquired, the created sentence related to the predetermined key point to the electronic apparatus.

A data processing program according to a twenty-fifth aspect is a program for causing a computer to execute processing of acquiring input data indicating a user input, performing specific processing using a generation model that generates information according to the input data, outputting a result of the specific processing to an electronic apparatus, acquiring a created sentence that is a sentence created by a first user as the input data, inputting a prompt including the acquired created sentence, a task that is solvable by content of the created sentence, and an instruction for generating a key point of the created sentence to the generation model as a first prompt to generate a task and a key point corresponding to the first prompt, storing the generated task and key point corresponding to the first prompt in a storage unit in association with the created sentence, inputting a prompt including a search query acquired as the input data, and an instruction for inquiring about a search intention of a second user assumed from the search query to the generation model as a second prompt to generate a search intention corresponding to the second prompt; inputting a prompt including an instruction for inquiring about a list of key points related to the task corresponding to the generated search intention corresponding to the second prompt to the generation model as a third prompt to generate a list of key points corresponding to the third prompt, and outputting the list of key points corresponding to the generated third prompt to the electronic apparatus, and outputting, in a case in which the input data indicating an interest of the second user in a predetermined key point in the list of key points is acquired, the created sentence related to the predetermined key point to the electronic apparatus.

A data processing apparatus according to a twenty-sixth aspect includes an acquisition unit that acquires input data indicating a user input, a processing unit that performs specific processing using a generation model that generates information according to the input data; and an output unit that outputs a result of the specific processing to an electronic apparatus, wherein the acquisition unit acquires destination information designating a destination and time point information designating a time point as the input data, the processing unit inputs a prompt including the destination information and the time point information acquired by the acquisition unit and an instruction for inquiring about an image of the destination at the time point indicated by the destination information and the time point information to the generation model as a first prompt to acquire the image of the destination corresponding to the first prompt, and inputs a prompt including the destination information, the time point information, and the image of the destination corresponding to the first prompt, and an instruction for generating a moving image of the destination at the time point indicated by the destination information and the time point information to the generation model as a second prompt to generate the moving image of the destination corresponding to the second prompt, and the output unit outputs the moving image of the destination corresponding to the second prompt generated by the processing unit to the electronic apparatus.

A data processing apparatus according to a twenty-seventh aspect is the data processing apparatus according to the twenty-sixth aspect, in which the acquisition unit acquires a theme of a moving image as the input data, and the processing unit inputs a prompt including the theme, the destination information, the time point information, the image of the destination corresponding to the first prompt, and an instruction for generating a moving image of the destination at the time point indicated by the destination information and the time point information to the generation model as a second prompt, and generates the moving image of the destination corresponding to the second prompt.

A data processing apparatus according to a twenty-eighth aspect is the data processing apparatus according to the twenty-sixth or twenty-seventh aspect, in which the acquisition unit acquires height information regarding a height of the user as the input data, and the processing unit generates the moving image of the destination corresponding to the second prompt in accordance with a height of an eye line derived on the basis of the height information.

A data processing apparatus according to a twenty-ninth aspect is the data processing apparatus according to any one of the twenty-sixth to twenty-eighth aspects, in which the acquisition unit acquires the time point information designating a plurality of time points as the input data, and the processing unit inputs a prompt including the destination information, the time point information, the image of the destination corresponding to the first prompt, and an instruction for generating a moving image of the destination at the time points indicated by the destination information and the time point information to the generation model as a second prompt, and generates the moving image of the destination corresponding to the second prompt in which the plurality of time points indicated by the time point information are arranged in time series.

A data processing apparatus according to a thirtieth aspect is the data processing apparatus according to any one of the twenty-sixth to twenty-ninth aspects, in which the acquisition unit acquires a moving speed of a camera at the time of moving and imaging as the input data, and the processing unit generates a moving image of the destination corresponding to the second prompt and reflecting the moving speed.

A data processing method according to a thirty-first aspect is a method of causing a computer to execute processing of acquiring input data indicating a user input, performing specific processing using a generation model that generates information according to the input data, outputting a result of the specific processing to an electronic apparatus, acquiring destination information designating a destination and time point information designating a time point as the input data, inputting a prompt including the acquired destination information and the time point information and an instruction for inquiring about an image of the destination at the time point indicated by the destination information and the time point information to the generation model as a first prompt to acquire the image of the destination corresponding to the first prompt, inputting a prompt including the destination information, the time point information, and the image of the destination corresponding to the first prompt, and an instruction for generating a moving image of the destination at the time point indicated by the destination information and the time point information to the generation model as a second prompt to generate the moving image of the destination corresponding to the second prompt, and outputting the generated moving image of the destination corresponding to the second prompt to the electronic apparatus.

A data processing program according to a thirty-second aspect is a program for causing a computer to execute processing of acquiring input data indicating a user input, performing specific processing using a generation model that generates information according to the input data, outputting a result of the specific processing to an electronic apparatus, acquiring destination information designating a destination and time point information designating a time point as the input data, inputting a prompt including the acquired destination information and the time point information and an instruction for inquiring about an image of the destination at the time point indicated by the destination information and the time point information to the generation model as a first prompt to acquire the image of the destination corresponding to the first prompt, inputting a prompt including the destination information, the time point information, and the image of the destination corresponding to the first prompt, and an instruction for generating a moving image of the destination at the time point indicated by the destination information and the time point information to the generation model as a second prompt to generate the moving image of the destination corresponding to the second prompt, and outputting the generated moving image of the destination corresponding to the second prompt to the electronic apparatus.

### BRIEF DESCRIPTION OF DRAWINGS

FIG. 1 schematically illustrates an example of a system 5 according to a first embodiment.

FIG. 2 schematically illustrates a functional configuration of a robot 100 according to the first embodiment.

FIG. 3 schematically illustrates an example of an operation flow in the robot 100 according to the first embodiment.

FIG. 4 schematically illustrates an example of a hardware configuration of a computer 1200 according to the first embodiment.

FIG. 5 illustrates an emotion map 400 on which a plurality of emotions are mapped according to the first embodiment.

FIG. 6 illustrates an emotion map 900 on which a plurality of emotions are mapped according to the first embodiment.

FIG. 7 schematically illustrates a functional configuration of an agent system according to the first embodiment.

FIG. 8 illustrates an example of an operation of the agent system according to the first embodiment.

FIG. 9 illustrates an example of an operation of the agent system according to the first embodiment.

FIG. 10 schematically illustrates a functional configuration of an agent system according to a second embodiment.

FIG. 11 illustrates an example of an interaction between a user 60, an agent A, and an agent U according to the second embodiment.

FIG. 12 illustrates an example of an interaction between the user 60, the agent A, and the agent U according to the second embodiment.

FIG. 13 illustrates an example of an operation of the agent system of the second embodiment.

FIG. 14 illustrates an example of a discussion between an agent U and a plurality of others X according to a third embodiment.

FIG. 15 illustrates an example of an interaction between a user 60 and a plurality of agents according to a fourth embodiment.

FIG. 16 schematically illustrates an example of an interaction processing flow of a plurality of agents according to the fourth embodiment.

FIG. 17 is a conceptual diagram illustrating an example of a configuration of a data processing system according to a fifth embodiment.

FIG. 18 is a conceptual diagram illustrating an example of main part functions of a data processing apparatus and a smart device according to the fifth embodiment.

FIG. 19 is a first block diagram illustrating an example of a functional configuration of a specific processing unit according to the fifth embodiment.

FIG. 20 is an example of an operation flow related to an operation in which the specific processing unit according to the fifth embodiment performs first specific processing.

FIG. 21 is an example of an operation flow related to an operation in which the specific processing unit according to the fifth embodiment performs second specific processing and third specific processing.

FIG. 22 is a first display example displayed on a display of a smart device according to the fifth embodiment.

FIG. 23 is a second display example displayed on the display of the smart device according to the fifth embodiment.

FIG. 24 is a second block diagram illustrating an example of a functional configuration of a specific processing unit according to a sixth embodiment.

FIG. 25 is a conceptual diagram illustrating an example of a configuration of a data processing system according to a ninth embodiment.

FIG. 26 illustrates an example of a headset type terminal according to the ninth embodiment.

FIG. 27 is a conceptual diagram illustrating an example of main part functions of a data processing apparatus and a headset type terminal according to the ninth embodiment.

FIG. 28 is a block diagram illustrating an example of a functional configuration of a specific processing unit according to the ninth embodiment.

FIG. 29 illustrates an example of an operation flow related to an operation in which the specific processing unit according to the ninth embodiment performs first specific processing and second specific processing.

### DESCRIPTION OF EMBODIMENTS

Hereinafter, embodiments of the disclosure will be described, but the following embodiments do not limit the disclosure. Not all combinations of features described in the embodiments are essential to the solution of the disclosure.

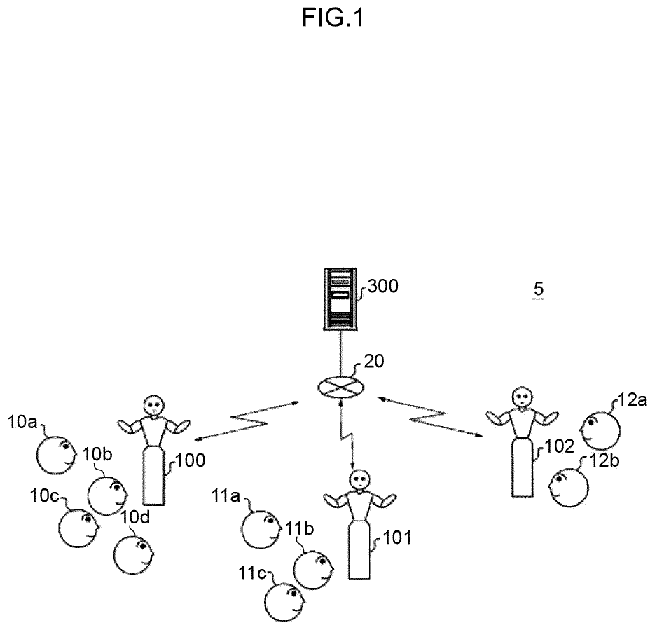

FIG. 1 schematically illustrates an example of a system 5 according to the present embodiment. The system 5 includes a robot 100, a robot 101, a robot 102, and a server 300. A user 10a, a user 10b, a user 10c, and a user 10d are users of the robot 100. The user 11a, the user 11b, and the user 11c are users of the robot 101. A user 12a and a user 12b are users of the robot 102. In the description of the present embodiment, the user 10a, the user 10b, the user 10c, and the user 10d may be collectively referred to as a user 10. The user 11a, the user 11b, and the user 11c may be collectively referred to as a user 11. The user 12a and the user 12b may be collectively referred to as a user 12. The robot 101 and the robot 102 have substantially the same functions as those of the robot 100. Therefore, the system 5 will be described focusing on the functions of the robot 100.

The robot 100 has a conversation with the user 10 and provides a video to the user 10. In this case, the robot 100 has a conversation with the user 10, provides a video to the user 10, and the like in cooperation with the server 300 and the like that can communicate via a communication network 20. For example, the robot 100 not only learns an appropriate conversation by itself, but also performs learning so that a conversation with the user 10 can be advanced more appropriately in cooperation with the server 300. The robot 100 causes the server 300 to record captured video data and the like of the user 10, requests the server 300 to transmit the video data and the like as necessary, and provides the video data and the like to the user 10.

The robot 100 has an emotion value indicating the type of its own emotion. For example, the robot 100 has emotion values indicating the intensities of respective emotions such as “happy”, “angry”, “sad”, “pleasant”, “pleased”, “displeased”, “safe”, “anxious”, “gloomy”, “excited”, “worried”, “relieved”, “sense of fulfillment”, “sense of emptiness”, and “normal”. For example, in a case in which the robot 100 has a conversation with the user 10 in a state in which the emotion value of excitement is great, the robot emits vocal sound at a fast speed. As described above, the robot 100 can express its own emotion by action.

The robot 100 may be configured to determine an action of the robot 100 corresponding to the emotion of the user 10 by matching a sentence generation model with an emotion engine. Specifically, the robot 100 may be configured to recognize an action of the user 10, determine an emotion of the user 10 for the action of the user, and determine an action of the robot 100 corresponding to the determined emotion.

More specifically, in a case in which the robot 100 recognizes the action of the user 10, the robot 100 automatically generates the action content to be taken by the robot with respect to the action of the user 10 by using the preset sentence generation model. The sentence generation model may be interpreted as an algorithm and an operation for automatic interaction processing using text. Since the sentence generation model is known as disclosed in, for example, Japanese Patent Application Laid-Open (JP-A) No. 2018-081444 and chatGPT (Internet search <URL: https://openai.com/blog/chatgpt>), a detailed description thereof will be omitted. Such a sentence generation model is configured by a large language model (LLM).

As described above, in the present embodiment, it is possible to reflect the emotions of the user 10 and the robot 100 and various types of linguistic information in the action of the robot 100 by combining the large language model and the emotion engine. That is, according to the present embodiment, a synergistic effect can be obtained by combining the sentence generation model and the emotion engine.

The robot 100 has a function of recognizing an action of the user 10. The robot 100 recognizes the action of the user 10 by analyzing a face image of the user 10 acquired by a camera function and the vocal sound of the user 10 acquired by a microphone function. The robot 100 determines an action to be executed by the robot 100 on the basis of the recognized action of the user 10 or the like.

The robot 100 stores a rule defining an action to be executed by the robot 100 on the basis of the emotion of the user 10, the emotion of the robot 100, and the action of the user 10, and performs various actions according to the rule.

Specifically, the robot 100 has a reaction rule for determining an action of the robot 100 on the basis of the emotion of the user 10, the emotion of the robot 100, and the action of the user 10. In the reaction rule, for example, in a case in which the action of the user 10 is “smiling”, an action of “smiling” is set as the action of the robot 100. In the reaction rule, an action of “apologizing” is defined as an action of the robot 100, with respect to a case in which the action of the user 10 is “angry”. In the reaction rule, an action of “answering” is defined as an action of the robot 100 with respect to a case in which the action of the user 10 is “inquiry”. In the reaction rule, an action of “talking” is defined as an action of the robot 100 with respect to a case in which the action of the user 10 is “gloomy”.

In a case in which the robot 100 recognizes that the action of the user 10 is “angry” on the basis of the reaction rule, the robot selects an action of “apologizing” defined in the reaction rule as the action to be executed by the robot 100. For example, in the case of selecting the action of “apologizing”, the robot 100 performs an action of “apologizing” and outputs vocal sound expressing the word “apologizing”.

In a case in which a condition that the emotion of the robot 100 is “normal” (that is, “happy”=0, “angry”=0, “sad”=0, and “pleasant”=0) and the state of the user 10 is “one person, lonely” is satisfied, it is defined that the emotion of the robot 100 can be changed to “worried” and the action of “talking” can be executed.

In a case in which the robot 100 recognizes that the current emotion of the robot 100 is “normal” and the user 10 is alone in a lonely state on the basis of the reaction rule, the emotion value of “sad” of the robot 100 is increased. The robot 100 selects the action of “talking” defined in the reaction rule as an action to be executed on the user 10. For example, in a case in which the action of “talking” is selected, the robot 100 converts a phrase “What's wrong?” indicating that the robot is concerned into vocal sound indicating that the robot is concerned, and outputs the vocal sound.

The robot 100 transmits, to the server 300, user reaction information indicating that a positive reaction has been obtained from the user 10 through this action. The user reaction information includes, for example, the user action of “angry”, the action of the robot 100 of “apologizing”, the positive reaction of the user 10, and an attribute of the user 10.

The server 300 stores the user reaction information received from the robot 100. The server 300 receives and stores the user reaction information not only from the robot 100 but also from each of the robot 101 and the robot 102. The server 300 analyzes the user reaction information from the robot 100, the robot 101, and the robot 102, and updates the reaction rule.

The robot 100 receives the updated reaction rule from the server 300 by inquiring the server 300 about the updated reaction rule. The robot 100 incorporates the updated reaction rule into the reaction rule stored in the robot 100. As a result, the robot 100 can incorporate the reaction rule acquired by the robot 101, the robot 102, or the like into its own reaction rule.

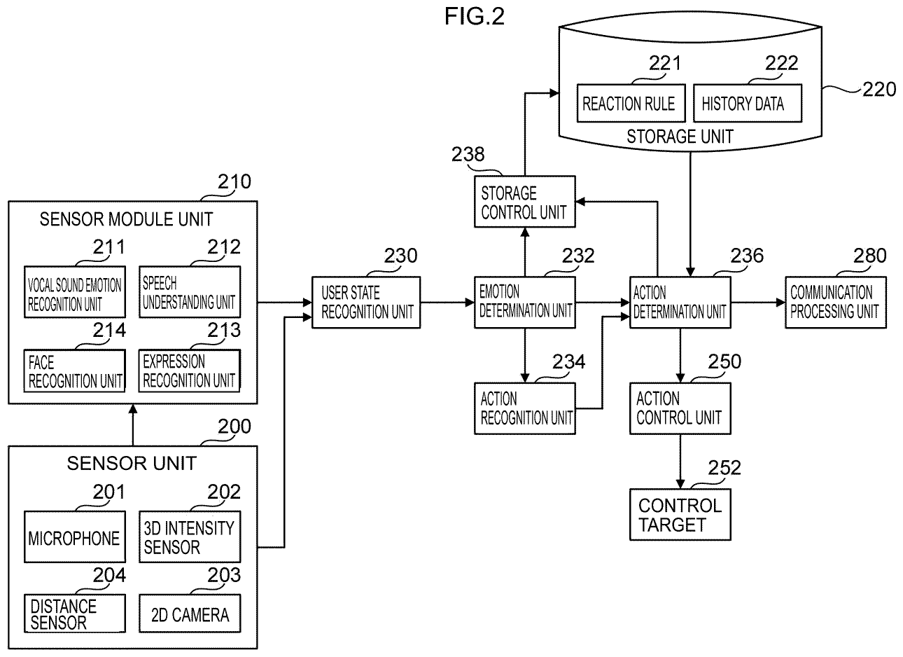

FIG. 2 schematically illustrates a functional configuration of the robot 100. The robot 100 includes a sensor unit 200, a sensor module unit 210, a storage unit 220, a user state recognition unit 230, an emotion determination unit 232, an action recognition unit 234, an action determination unit 236, a storage control unit 238, an action control unit 250, a control target 252, and a communication processing unit 280.

Examples of the control target 252 include a display device, a speaker, an LED of an eye portion, and motors that drive an arm, a hand, a foot, and the like. The posture and the gesture of the robot 100 are controlled by controlling motors for arms, hands, and feet. Some of the emotions of the robot 100 can be expressed by controlling these motors. The expression of the robot 100 can be expressed by controlling a light emission state of the LED of the eye portion of the robot 100. The posture, the gesture, and the expression of the robot 100 are examples of the attitude of the robot 100.

The sensor unit 200 includes a microphone 201, a 3D depth sensor 202, a 2D camera 203, and a distance sensor 204. The microphone 201 continuously detects vocal sound and outputs vocal sound data. The microphone 201 may be provided on the head of the robot 100 and may have a function of performing binaural recording. The 3D depth sensor 202 analyzes infrared patterns from infrared images continuously captured by an infrared camera by continuously applying the infrared patterns, and detects an outline of an object. The 2D camera 203 is an example of an image sensor. The 2D camera 203 captures an image with visible light and generates image information of visible light. The distance sensor 204 detects a distance to an object by emitting, for example, laser light or ultrasonic waves. The sensor unit 200 may further include a clock, a gyro sensor, a touch sensor, a sensor for motor feedback, and the like.

Among the constituents of the robot 100 illustrated in FIG. 2, the constituents other than the control target 252 and the sensor unit 200 are examples of the constituents included in the action control system included in the robot 100. The action control system of the robot 100 controls the control target 252.

The storage unit 220 includes a reaction rule 221 and history data 222. The history data 222 includes past emotion values and a history of actions of the user 10. The emotion values and the history of actions are recorded for each user 10 by being associated with identification information of the user 10, for example. At least a part of the storage unit 220 is implemented by a storage medium such as a memory. A person DB that stores a face image of the user 10, attribute information of the user 10, and the like may be included. Among the constituents of the robot 100 illustrated in FIG. 2, the functions of the constituents other than the control target 252, the sensor unit 200, and the storage unit 220 can be realized by a CPU operating on the basis of a program. For example, the functions of these constituents can be implemented as the operation of the CPU by basic software (OS) and a program operating on the OS.

The sensor module unit 210 includes vocal sound emotion recognition unit 211, a speech understanding unit 212, an expression recognition unit 213, and a face recognition unit 214. Information detected by the sensor unit 200 is input to the sensor module unit 210. The sensor module unit 210 analyzes information detected by the sensor unit 200 and outputs an analysis result to the user state recognition unit 230.

The vocal sound emotion recognition unit 211 of the sensor module unit 210 analyzes the vocal sound of the user 10 detected by the microphone 201 to recognize the emotion of the user 10. For example, the vocal sound emotion recognition unit 211 extracts a feature amount such as a frequency component of the vocal sound and recognizes the emotion of the user 10 on the basis of the extracted feature amount. The speech understanding unit 212 analyzes the vocal sound of the user 10 detected by the microphone 201 and outputs text information indicating the speech content of the user 10.

The expression recognition unit 213 recognizes the expression of the user 10 and the emotion of the user 10 from the image of the user 10 captured by the 2D camera 203. For example, the expression recognition unit 213 recognizes the expression and the emotion of the user 10 on the basis of the shapes, positional relationships, and the like of the eyes and the mouth.

The face recognition unit 214 recognizes the face of the user 10. The face recognition unit 214 recognizes the user 10 by matching a face image stored in a person DB (not illustrated) with a face image of the user 10 captured by the 2D camera 203.

The user state recognition unit 230 recognizes a state of the user 10 on the basis of the information analyzed by the sensor module unit 210. For example, processing mainly related to perception is performed by using the analysis result from the sensor module unit 210. For example, perception information such as “There is one father.” and “The probability that the father does not smile is 90%.” is generated. Processing of understanding the meaning of the generated perception information is performed. For example, semantic information such as “One father looks lonely.” is generated.

The emotion determination unit 232 determines an emotion value indicating the emotion of the user 10 on the basis of the information analyzed by the sensor module unit 210 and the state of the user 10 recognized by the user state recognition unit 230. For example, the information analyzed by the sensor module unit 210 and the recognized state of the user 10 are input to a neural network trained in advance, and an emotion value indicating the emotion of the user 10 is acquired.

Here, the emotion value indicating the emotion of the user 10 is a value indicating whether the emotion of the user is positive or negative. For example, in a case in which the emotion of the user is a bright emotion accompanied with pleasure or comfort, such as “happy”, “pleasant”, “pleased”, “safe”, “excited”, “relieved”, and “sense of fulfillment”, a positive value is indicated, and the value becomes larger as the emotion becomes brighter. In a case in which the emotion of the user is an emotion that causes an unpleasant feeling for the user, such as “angry”, “sad”, “displeased”, “anxious”, “gloomy”, “worried”, and “sense of emptiness”, a negative value is indicated, and an absolute value of the negative value increases as the user feels more unpleasant. In a case in which the emotion of the user is not included in any of the above emotions (“normal”), a value of 0 is indicated.

The emotion determination unit 232 determines an emotion value indicating the emotion of the robot 100 on the basis of the information analyzed by the sensor module unit 210 and the state of the user 10 recognized by the user state recognition unit 230.

The emotion value of the robot 100 includes an emotion value for each of the plurality of emotion classifications, and is, for example, a value (0 to 5) indicating the intensity of each of “happy”, “angry”, “sad”, and “pleasant”.

Specifically, the emotion determination unit 232 determines an emotion value indicating the emotion of the robot 100 according to a rule for updating the emotion value of the robot 100, the rule being defined in association with the information analyzed by the sensor module unit 210 and the state of the user 10 recognized by the user state recognition unit 230.

For example, in a case in which the user state recognition unit 230 recognizes that the user 10 looks lonely, the emotion determination unit 232 increases the emotion value of “sad” of the robot 100. In a case in which the user state recognition unit 230 recognizes that the user 10 has a smiling face, the emotion value of “happy” of the robot 100 is increased.

The emotion determination unit 232 may determine the emotion value indicating the emotion of the robot 100 in further consideration of the state of the robot 100. For example, in a case in which a remaining battery level of the robot 100 is low or in a case in which the surrounding environment of the robot 100 is dark, the emotion value of “sad” of the robot 100 may be increased. In the case of the user 10 continuously talking to the robot even though the remaining battery level is low, the emotion value of “angry” may be increased.

The action recognition unit 234 recognizes an action of the user 10 on the basis of the information analyzed by the sensor module unit 210 and the state of the user 10 recognized by the user state recognition unit 230. For example, the information analyzed by the sensor module unit 210 and the recognized state of the user 10 are input to a neural network trained in advance, probabilities of a plurality of predetermined action classifications (for example, “smile”, “angry”, “ask a question”, and “gloomy”) are acquired, and an action classification having the highest probability is recognized as the action of the user 10.

As described above, in the present embodiment, the robot 100 acquires the speech content of the user 10 after identifying the user 10, but in acquiring and using the speech content, the action control system of the robot 100 according to the present embodiment considers protection of personal information and privacy of the user 10 in addition to acquiring necessary consent according to laws and regulations from the user 10.

The action determination unit 236 determines an action corresponding to the action of the user 10 recognized by the action recognition unit 234 on the basis of the current emotion value of the user 10 determined by the emotion determination unit 232, the history data 222 of the past emotion values determined by the emotion determination unit 232 before the current emotion value of the user 10 is determined, and the emotion value of the robot 100. In the present embodiment, a case in which the action determination unit 236 uses one most recent emotion value included in the history data 222 as the past emotion value of the user 10 will be described, but the disclosed technology is not limited to this aspect. For example, the action determination unit 236 may use a plurality of most recent emotion values as the past emotion values of the user 10, or may use emotion values that are earlier by a unit period such as one day before. The action determination unit 236 may determine an action corresponding to the action of the user 10 in further consideration of the history of the past emotion values of the robot 100 in addition to the current emotion value of the robot 100. The action determined by the action determination unit 236 includes a gesture performed by the robot 100 or speech content of the robot 100.

The action determination unit 236 according to the present embodiment determines the action of the robot 100 on the basis of a combination of the past emotion value and the current emotion value of the user 10, the emotion value of the robot 100, the action of the user 10, and the reaction rule 221, as an action corresponding to the action of the user 10. For example, in a case in which the past emotion value of the user 10 is a positive value and the current emotion value is a negative value, the action determination unit 236 determines an action for positively changing the emotion value of the user 10 as an action corresponding to the action of the user 10.

The reaction rule 221 defines an action of the robot 100 according to the combination of the past emotion value and the current emotion value of the user 10, the emotion value of the robot 100, and the action of the user 10. For example, in a case in which the past emotion value of the user 10 is a positive value, the current emotion value is a negative value, and the action of the user 10 is gloomy, a combination of a gesture and speech content at the time of making an inquiry to encourage the user 10 including a gesture is defined as the action of the robot 100.

For example, the reaction rule 221 defines an action of the robot 100 for all combinations of patterns of emotion values of the robot 100 (1296 patterns that is the fourth power of six values of the values “0” to “5” of “happy”, “angry”, “sad”, and “pleasant”), a pattern of the combination of the past emotion value and the current emotion value of the user 10, and an action pattern of the user 10. That is, for each pattern of the emotion value of the robot 100, the action of the robot 100 according to the action pattern of the user 10 is defined for each of a plurality of combinations such as combinations of the past emotion value and the current emotion value of the user 10 being a negative value and a negative value, a negative value and a positive value, a positive value and a negative value, a positive value and a positive value, a negative value and normal, and normal and normal. The action determination unit 236 may transition to an operation mode of determining the action of the robot 100 by using the history data 222, for example, in a case in which the user 10 has made speech that intends a conversation continued from a past topic such as “I want to talk about the topic I discussed earlier”.

In the reaction rule 221, at least one of a gesture and statement content may be defined as an action of the robot 100 for each pattern (1296 patterns) of the emotion values of the robot 100 at the maximum. Alternatively, in the reaction rule 221, at least one of a gesture and statement content may be defined as an action of the robot 100 for each of groups of the patterns of the emotion values of the robot 100.

The intensity of each gesture included in the action of the robot 100 defined in the reaction rule 221 is defined in advance. In each piece of speech content included in the action of the robot 100 defined in the reaction rule 221, the intensity of the speech content is defined in advance.

The storage control unit 238 determines whether or not to store data including the action of the user 10 in the history data 222 on the basis of the intensity of the action predefined for the action determined by the action determination unit 236 and the emotion value of the robot 100 determined by the emotion determination unit 232.

Specifically, in a case in which a total value of the intensities that is a sum of a sum total of the emotion values for the plurality of respective emotion classifications of the robot 100, the intensity predefined for the gesture included in the action determined by the action determination unit 236, and the intensity predefined for the speech content included in the action determined by the action determination unit 236 is a threshold or more, it is determined to store data including the action of the user 10 in the history data 222.

In a case in which the storage control unit 238 determines to store the data including the action of the user 10 in the history data 222, the action determined by the action determination unit 236, information (for example, any surrounding information including data such as vocal sound, an image, and a smell at the place) analyzed by the sensor module unit 210 from the current time point to a certain period before, and a state (for example, the expression and the emotion of the user 10) of the user 10 recognized by the user state recognition unit 230 are stored in the history data 222.

The action control unit 250 controls the control target 252 on the basis of the action determined by the action determination unit 236. For example, in a case in which the action determination unit 236 determines an action including speech, the action control unit 250 causes a speaker included in the control target 252 to output vocal sound. In this case, the action control unit 250 may determine an emission speed of the vocal sound on the basis of the emotion value of the robot 100. For example, the action control unit 250 determines a higher vocal sound emission speed as the emotion value of the robot 100 becomes greater. As described above, the action control unit 250 determines an execution form of the action determined by the action determination unit 236 on the basis of the emotion value determined by the emotion determination unit 232.

The action control unit 250 may recognize a change in emotion of the user 10 with respect to execution of the action determined by the action determination unit 236. For example, the change in emotion may be recognized on the basis of the vocal sound or expression of the user 10. A change in the emotion of the user 10 may be recognized on the basis of detection of an impact by the touch sensor included in the sensor unit 200. In a case in which an impact is detected by the touch sensor included in the sensor unit 200, it may be recognized that the emotion of the user 10 is worsened, or in a case in which it is determined that the reaction of the user 10 is smiling or happy from the detection result in the touch sensor included in the sensor unit 200, it may be recognized that the emotion of the user 10 is improved. Information indicating the reaction of the user 10 is output to the communication processing unit 280.

After the action control unit 250 executes the action determined by the action determination unit 236 in the execution form determined according to the emotion of the robot 100, the emotion determination unit 232 further changes the emotion value of the robot 100 on the basis of the user's reaction to the execution of the action. Specifically, the emotion determination unit 232 increases the emotion value of “happy” of the robot 100 in a case in which the user's reaction to the action determined by the action determination unit 236 performed on the user in the execution form determined by the action control unit 250 is not bad, and the emotion determination unit 232 increases the emotion value of “sad” of the robot 100 in a case in which the user's reaction to the action determined by the action determination unit 236 performed on the user in the execution form determined by the action control unit 250 is poor.

The action control unit 250 expresses the emotion of the robot 100 on the basis of the determined emotion value of the robot 100. For example, in a case in which the emotion value of “happy” of the robot 100 is increased, the action control unit 250 controls the control target 252 to cause the robot 100 to perform a gesture of being happy. In a case in which the emotion value of “sad” of the robot 100 is increased, the action control unit 250 controls the control target 252 so that the posture of the robot 100 becomes a head-drooping posture.

The communication processing unit 280 performs communication with the server 300. As described above, the communication processing unit 280 transmits the user reaction information to the server 300. The communication processing unit 280 receives the updated reaction rule from the server 300. Upon receiving the updated reaction rule from the server 300, the communication processing unit 280 updates the reaction rule 221.

The server 300 performs communication between the robot 100, the robot 101, and the robot 102 and the server 300, receives the user reaction information transmitted from the robot 100, and updates the reaction rule on the basis of the reaction rule including the action for which a positive reaction has been obtained.

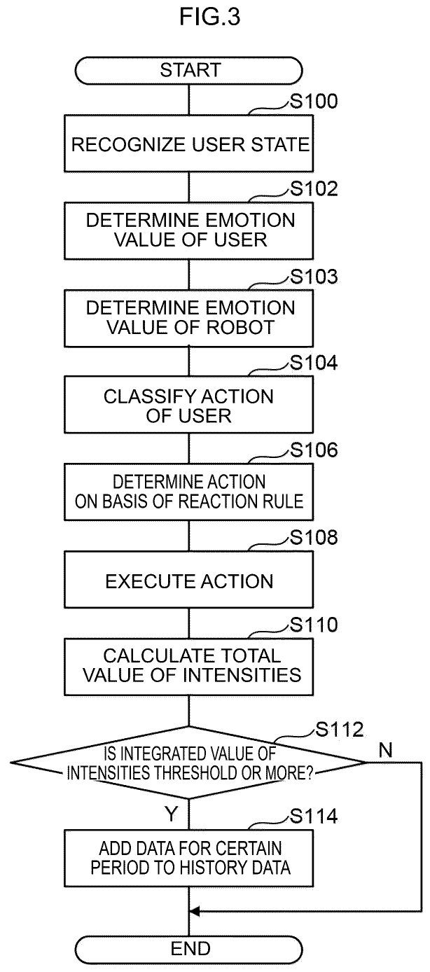

FIG. 3 schematically illustrates an example of an operation flow related to an operation of determining an action of the robot 100. The operation flow illustrated in FIG. 3 is repeatedly executed. In this case, it is assumed that information analyzed by the sensor module unit 210 is input. “S” in the operation flow represents a step to be executed.

First, in step S100, the user state recognition unit 230 recognizes a state of the user 10 on the basis of the information analyzed by the sensor module unit 210.

In step S102, the emotion determination unit 232 determines an emotion value indicating the emotion of the user 10 on the basis of the information analyzed by the sensor module unit 210 and the state of the user 10 recognized by the user state recognition unit 230.

In step S103, the emotion determination unit 232 determines an emotion value indicating the emotion of the robot 100 on the basis of the information analyzed by the sensor module unit 210 and the state of the user 10 recognized by the user state recognition unit 230. The emotion determination unit 232 adds the determined emotion value of the user 10 to the history data 222.

In step S104, the action recognition unit 234 recognizes an action classification of the user 10 on the basis of the information analyzed by the sensor module unit 210 and the state of the user 10 recognized by the user state recognition unit 230.

In step S106, the action determination unit 236 determines an action of the robot 100 on the basis of a combination of the current emotion value of the user 10 determined in step S102 and the past emotion value included in the history data 222, the emotion value of the robot 100, the action of the user 10 recognized by the action recognition unit 234, and the reaction rule 221.

In step S108, the action control unit 250 controls the control target 252 on the basis of the action determined by the action determination unit 236.

In step S110, the storage control unit 238 calculates a total value of the intensities on the basis of the intensity of the action predefined for the action determined by the action determination unit 236 and the emotion value of the robot 100 determined by the emotion determination unit 232.

In step S112, the storage control unit 238 determines whether or not the total value of the intensities is a threshold or more. In a case in which the total value of the intensities is less than the threshold, the data including the action of the user 10 is not stored in the history data 222, and the processing is ended. On the other hand, in a case in which the total value of the intensities is the threshold or more, the processing proceeds to step S114.

In step S114, the action determined by the action determination unit 236, the information analyzed by the sensor module unit 210 from the current time point to a certain period before, and the state of the user 10 recognized by the user state recognition unit 230 are stored in the history data 222.

As described above, the robot 100 determines the emotion value indicating the emotion of the robot 100 on the basis of the user state, and determines whether or not to store data including the action of the user 10 in the history data 222 on the basis of the emotion value of the robot 100. As a result, the capacity of the history data 222 that stores data including an action of the user 10 can be suppressed. For example, in a case in which the robot 100 determines that the user state after 10 years is the same as the user state of 10 years ago, the robot 100 reads the history data 222 of 10 years ago, and thus, can present the state of the user 10 of 10 years ago (for example, an expression and an emotion of the user 10), and further, any surrounding information including data such as vocal sound, an image, and a smell at the place to the user 10.

According to the robot 100, it is possible to cause the robot 100 to execute an appropriate action with respect to the action of the user 10. Conventionally, an action of a user is classified to determine an action including an expression or an appearance of a robot. On the other hand, the robot 100 determines the current emotion value of the user 10, and executes an action on the user 10 on the basis of the past emotion value and the current emotion value. Therefore, for example, in a case in which the user 10 who was fine yesterday is depressed today, the robot 100 may say, “You were fine yesterday. What's wrong with you today?”. The robot 100 may also make speech with a gesture. For example, in a case in which the user 10 who was depressed yesterday is fine today, the robot 100 may say, “You were depressed yesterday, but you look fine today?”. For example, in a case in which the user 10 who was fine yesterday is better today than yesterday, the robot 100 may say, “You are better today than yesterday. What's better than yesterday?”. For example, the robot 100 may make speech such as “Recently, the mood is stable, which is good.” to the user 10 whose emotion value is 0 or more and whose state in which the fluctuation range of the emotion value is within a certain range continues.

For example, in a case in which the robot 100 asks a question of “Did you finish the homework that you said yesterday?” to the user 10 and an answer of “I did it” is obtained from the user 10, the robot may make affirmative speech such as “Good!” and make an affirmative gesture such as applause or thumbs-up. For example, in a case in which the user 10 says, “The presentation I talked about the day before yesterday was successful”, the robot 100 can make affirmative speech such as “Good job!” and also make the above affirmative gesture. As described above, the robot 100 performs an action based on the history of the state of the user 10, whereby the user 10 can be expected to feel a sense of closeness to the robot 100.

In the above embodiment, the case in which the robot 100 recognizes the user 10 by using the face image of the user 10 has been described, but the disclosed technology is not limited to this aspect. For example, the robot 100 may recognize the user 10 by using vocal sound output by the user 10, a mail address of the user 10, an ID of an SNS of the user 10, an ID card in which a wireless IC tag is built and which is possessed by the user 10, or the like.

The robot 100 is an example of an electronic apparatus including an action control system. An application target of the action control system is not limited to the robot 100, and the action control system can be applied to various electronic apparatuses. The functions of the server 300 may be implemented by one or more computers. At least some functions of the server 300 may be implemented by a virtual machine. At least some of the functions of the server 300 may be implemented in a cloud.

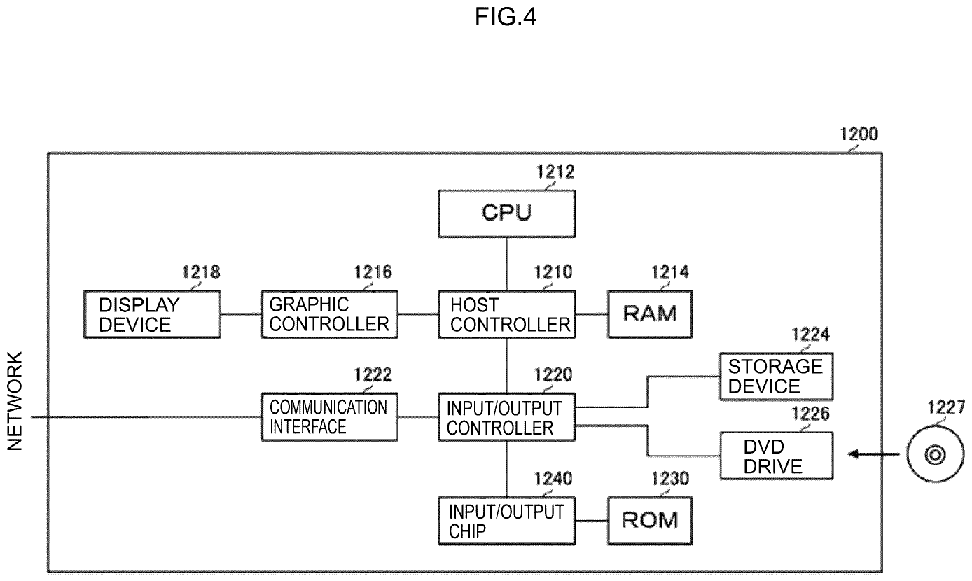

FIG. 4 schematically illustrates an example of a hardware configuration of a computer 1200 that functions as the robot 100 and the server 300. A program installed in the computer 1200 can cause the computer 1200 to function as one or more “units” of the device according to the present embodiment, or cause the computer 1200 to execute an operation associated with the device according to the present embodiment or one or more “units” thereof, and/or cause the computer 1200 to execute a process according to the present embodiment or a stage of the process. Such a program may be executed by a CPU 1212 to cause the computer 1200 to execute certain operations associated with some or all of the blocks in the flowcharts and block diagrams described herein.

The computer 1200 according to the present embodiment includes a CPU 1212, a RAM 1214, and a graphic controller 1216, which are connected to each other via a host controller 1210. The computer 1200 also includes input/output units such as a communication interface 1222, a storage device 1224, a DVD drive 1226, and an IC card drive, which are connected to the host controller 1210 via an input/output controller 1220. The DVD drive 1226 may be a DVD-ROM drive, a DVD-RAM drive, or the like. The storage device 1224 may be a hard disk drive, a solid state drive, or the like. The computer 1200 also includes a ROM 1230 and legacy input/output units such as a keyboard, which are connected to the input/output controller 1220 via an input/output chip 1240.

The CPU 1212 operates according to programs stored in the ROM 1230 and the RAM 1214, thereby controlling each unit. The graphic controller 1216 acquires image data generated by the CPU 1212 in a frame buffer or the like provided in the RAM 1214 or itself, and causes the image data to be displayed on the display device 1218.

The communication interface 1222 communicates with other electronic devices via a network. The storage device 1224 stores programs and data used by the CPU 1212 in the computer 1200. The DVD drive 1226 reads a program or data from the DVD-ROM 1227 or the like and provides the program or data to the storage device 1224. The IC card drive reads a program and data from the IC card and/or writes the program and data to the IC card.

The ROM 1230 stores therein a boot program or the like executed by the computer 1200 at the time of activation and/or a program depending on hardware of the computer 1200. The input/output chip 1240 may also connect various input/output units to the input/output controller 1220 via a USB port, a parallel port, a serial port, a keyboard port, a mouse port, or the like.

The program is provided by a computer-readable storage medium such as the DVD-ROM 1227 or an IC card. The program is read from a computer-readable storage medium, installed in the storage device 1224, the RAM 1214, or the ROM 1230, which are also examples of a computer-readable storage medium, and executed by the CPU 1212. The information processing described in such a program is read by the computer 1200 and provides cooperation between the program and the various types of hardware resources. A device or a method may be configured by implementing an operation or processing of information according to use of the computer 1200.

For example, in a case in which communication is executed between the computer 1200 and an external device, the CPU 1212 may execute a communication program loaded in the RAM 1214 and instruct the communication interface 1222 to perform communication processing on the basis of processing described in the communication program. Under the control of the CPU 1212, the communication interface 1222 reads transmission data stored in a transmission buffer area provided in a recording medium such as the RAM 1214, the storage device 1224, the DVD-ROM 1227, or the IC card, transmits the read transmission data to the network, or writes reception data received from the network to a reception buffer area or the like provided on the recording medium.

The CPU 1212 may cause the RAM 1214 to read all or a necessary portion of a file or database stored in an external recording medium such as the storage device 1224, the DVD drive 1226 (DVD-ROM 1227), or the IC card, and may execute various types of processing on data in the RAM 1214. Next, the CPU 1212 may write back the processed data to the external recording medium.

Various types of information such as various types of programs, data, tables, and databases may be stored in a recording medium and subjected to information processing. The CPU 1212 may execute various types of processing on the data read from the RAM 1214, including various types of operations, information processing, condition determination, conditional branching, unconditional branching, information retrieval/replacement, and the like, which are described throughout the disclosure and specified by a command sequence of a program, and writes back the results to the RAM 1214. The CPU 1212 may search for information in a file, a database, or the like in the recording medium. For example, in a case in which a plurality of entries each having an attribute value of a first attribute associated with an attribute value of a second attribute is stored in the recording medium, the CPU 1212 may search for an entry in which the attribute value of the first attribute matches a specified condition from the plurality of entries, read the attribute value of the second attribute stored in the entry, and thus acquire the attribute value of the second attribute associated with the first attribute satisfying a predetermined condition.

The programs or software modules described above may be stored in the computer 1200 or a computer-readable storage medium near the computer 1200. A recording medium such as a hard disk or a RAM provided in a server system connected to a dedicated communication network or the Internet may be used as a computer-readable storage medium, and provides a program to the computer 1200 via the network.

Blocks in the flowcharts and the block diagrams in the present embodiments may represent stages of a process in which an operation is performed or “units” of a device having a role of performing an operation. Specific stages and “units” may be implemented by a dedicated circuit, a programmable circuit supplied along with computer readable instructions stored on a computer readable storage medium, and/or a processor supplied along with computer readable instructions stored on a computer readable storage medium. Dedicated circuits may include digital and/or analog hardware circuits, and may include integrated circuits (ICs) and/or discrete circuits. Programmable circuits may include reconfigurable hardware circuits including, for example, AND, OR, XOR, NAND, NOR, and other logical operations, flip-flops, registers, and memory elements, such as field programmable gate arrays (FPGA) and programmable logic arrays (PLA).

Computer readable storage media may include any tangible device capable of storing instructions executed by a suitable device, and, as a result, a computer readable storage medium having instructions stored thereon has a product including instructions that may be executed to create means for executing operations designated in the flowcharts or block diagrams. Examples of the computer readable storage medium may include an electronic storage medium, a magnetic storage medium, an optical storage medium, an electromagnetic storage medium, and a semiconductor storage medium. More specific examples of the computer readable storage medium may include a Floppy (registered trademark) disk, a diskette, a hard disk, a random access memory (RAM), a read-only memory (ROM), an erasable programmable read-only memory (an EPROM or a flash memory), an electrically erasable programmable read-only memory (EEPROM), a static random access memory (SRAM), a compact disc read-only memory (CD-ROM), a digital versatile disk (DVD), a Blu-Ray (registered trademark) disk, a memory stick, and an integrated circuit card.

The computer readable instructions may include either source codes or object codes written in any combination of one or more programming languages, including assembler instructions, instruction-set-architecture (ISA) instructions, machine instructions, machine-dependent instructions, microcode, firmware instructions, state-setting data, or an object oriented programming language such as Smalltalk (registered trademark), or JAVA (registered trademark), C++, and conventional procedural programming languages such as the “C” programming language or similar programming languages.

The computer readable instructions may be provided to a processor of a general purpose computer, a special purpose computer, or another programmable data processing apparatus, or a programmable circuit locally or via a local area network (LAN) or a wide area network (WAN) such as the Internet, in order to cause the processor of the general purpose computer, the special purpose computer, or another programmable data processing apparatus or the programmable circuit to execute the computer readable instructions to generate means for executing operations designated in the flowcharts or the block diagrams. Examples of the processor include a computer processor, a processing unit, a microprocessor, a digital signal processor, a controller, and a microcontroller.

Although the technology of the disclosure has been described by using each embodiment, the technology of the disclosure is not limited to the scope disclosed in each embodiment. It is apparent to those skilled in the art that various modifications or improvements can be made to the above embodiments. It is apparent from the description of the claims that modes to which such modifications or improvements are added can also be included in the technical scope of the disclosure.

The order of execution of each piece of processing of operations, procedures, steps, stages, and the like in the devices, the systems, the programs, and the methods shown in the claims, the specification, and the drawings can be realized in any order unless “before”, “prior to”, or the like is explicitly stated, and unless the output of the previous processing is used in the later processing. Even in a case in which the operation flow in the claims, the specification, and the drawings is described by using “first,”, “next,”, and the like for convenience, this does not mean that it is essential to perform in this order.

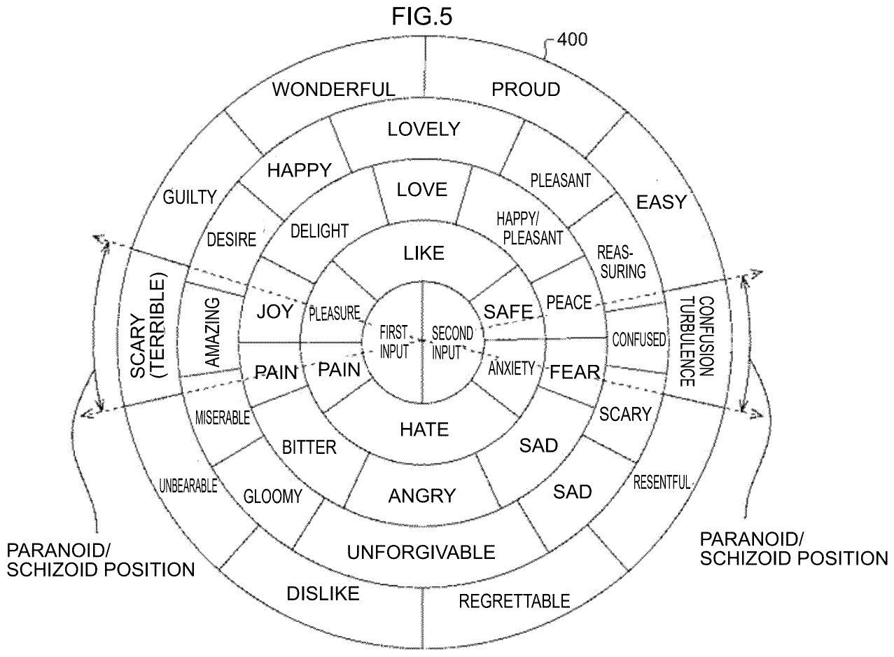

The emotion determination unit 232 may determine an emotion of the user according to a specific mapping. Specifically, the emotion determination unit 232 may determine an emotion of the user on the basis of an emotion map (see FIG. 5) that is a specific mapping.

FIG. 5 is a diagram illustrating an emotion map 400 on which a plurality of emotions are mapped. In the emotion map 400, emotions are disposed concentrically radially from the center. The closer to the center of the concentric circle, the more the emotion of the primitive state is disposed. Emotions indicating states and actions generated from the state of mind are disposed outside the concentric circle. The emotion is a concept including an affection and a mental state. On the left side of the concentric circle, emotions generated from reactions generally occurring in the brain are disposed. On the right side of the concentric circle, emotions induced by situation determination are generally disposed. In the up and down directions of the concentric circles, emotions generated from reactions generally occurring in the brain and induced by situational determination are disposed. The emotion of “pleased” is disposed on the upper side of the concentric circle, and the emotion of “displeased” is disposed on the lower side. As described above, in the emotion map 400, a plurality of emotions are mapped on the basis of a structure in which emotions occur, and emotions that are likely to occur at the same time are mapped close to each other.

(1) For example, in a case in which the emotion engine, which is the emotion determination unit 232 of the robot 100, detects an emotion at about 100 msec, determination of the reaction operation (for example, a quick-response) of the robot 100 may be performed at a timing at which a detection frequency is set to be similar to at least the detection frequency (100 msec) of the emotion engine, or may be performed at a timing at which the detection frequency is set to be higher than the detection frequency. The detection frequency of the emotion engine may be interpreted as a sampling rate.

The emotion is detected in about 100 msec, and the reaction operation (for example, a quick-response) is performed immediately in conjunction with the detection, whereby an unnatural quick-response is eliminated, and an interaction in which natural air is read can be realized. The robot 100 performs a reaction operation (quick-response or the like) according to the directionality and the degree (intensity) of the mandala of the emotion map 400. The detection frequency (sampling rate) of the emotion engine is not limited to 100 ms, and may be changed according to a situation (for example, in the case of playing sports), the age of the user, or the like.

(2) In comparison with the emotion map 400, the directionality of the emotion and the intensity of the degree thereof may be set in advance, and the quick-response motion and the strength of the quick-response may be set. For example, in a case in which the robot 100 feels a sense of stability, safety, or the like, the robot 100 continues listening to the speech while nodding. In a case in which the robot 100 feels anxious, hesitated, or suspicious, the robot 100 may tilt its head or stop swinging.

These emotions are distributed in the 3:00 direction of the emotion map 400, and usually come and go between safety and anxiety. In the right half of the emotion map 400, situation recognition is superior to internal sensation, and thus gives a calm impression.

(3) In a case in which the robot 100 feels good in the case of receiving the compliment, a filler “Oh” may come in front of the line. In a case in which the robot feels pain in the case of receiving harsh words, a filler “Ohh!” may come in front of the line. A physical reaction such as a gesture of the robot 100 crouching while saying “Ohh!” may be included. These emotions are distributed around 9:00 on the emotion map 400.

(4) In the left half of the emotion map 400, internal sensation (reaction) is superior to situation recognition. Therefore, an impression of unintentional reaction may be given.

In a case in which the robot 100 has a favorable feeling in situation recognition while remembering internal sensation (reaction) of satisfaction, the robot 100 may nod deeply while looking at the other party, or may say “yeah, yeah”. As described above, the robot 100 may generate a balanced favorable feeling to the other party, that is, an action such as allowance or tolerance to the other party. Such emotions are distributed around 12:00 in the emotion map 400.

In contrast, in a case in which the robot 100 feels antipathy in the situation recognition while remembering internal sensation (reaction) of displeasure, the robot 100 may shake its head sideways, and may turn red the LED of the eye and look at the other party in the case of feeling hatred. Such emotions are distributed around 6:00 in the emotion map 400.

(5) Since the inside of the emotion map 400 represents the inside of the mind and the outside of the emotion map 400 represents an action, the emotion is more visible (appears in the action) toward the outside of the emotion map 400.

(6) In a case in which the robot 100 listens to person's speech while remembering the safety distributed around 3:00 on the emotion map 400, the robot slightly shakes its head vertically and says “uh-huh”. However, in the direction of love around 12:00, the robot may perform strong nodding such as shaking its head deeply vertically.

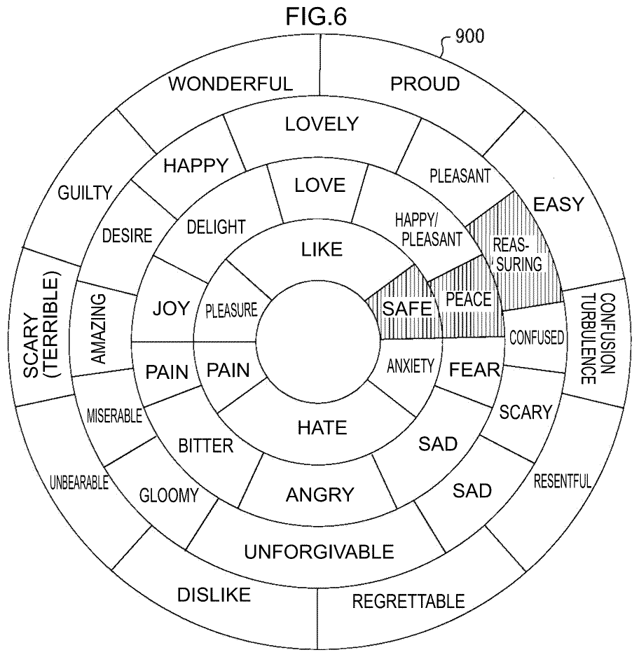

The emotion determination unit 232 inputs the information analyzed by the sensor module unit 210 and the recognized state of the user 10 to a neural network trained in advance, acquires an emotion value indicating each emotion indicated in the emotion map 400, and determines an emotion of the user 10. This neural network is trained in advance on the basis of a plurality of pieces of learning data that is a combination of the information analyzed by the sensor module unit 210 and the recognized state of the user 10 and the emotion value indicating each emotion indicated in the emotion map 400. This neural network is trained such that, as in an emotion map 900 illustrated in FIG. 6, emotions disposed close to each other have close values. FIG. 6 illustrates an example in which a plurality of emotions such as “safe”, “calm”, and “reassuring” have close emotion values.

The emotion determination unit 232 may determine an emotion of the robot 100 according to a specific mapping. Specifically, the emotion determination unit 232 inputs the information analyzed by the sensor module unit 210, the state of the user 10 recognized by the user state recognition unit 230, and the state of the robot 100 to a neural network trained in advance, acquires an emotion value indicating each emotion indicated in the emotion map 400, and determines an emotion of the robot 100. This neural network is trained in advance on the basis of a plurality of pieces of learning data that is a combination of the information analyzed by the sensor module unit 210, the recognized state of the user 10, the state of the robot 100, and the emotion value indicating each emotion illustrated in the emotion map 400. For example, the neural network is trained on the basis of learning data indicating that the emotion value “3” of “happy” is obtained in a case in which the robot 100 is recognized as being stroked by the user 10 from the output of the touch sensor (not illustrated), and learning data indicating that the emotion value “3” of “angry” is obtained in a case in which the robot 100 is recognized as being hit by the user 10 from the output of the acceleration sensor (not illustrated). This neural network is trained such that, as in the emotion map 900 illustrated in FIG. 6, emotions disposed close to each other have close values.

The action determination unit 236 adds a fixed sentence for inquiry about the action content of the robot corresponding to the action of the user to text representing the action of the user, the emotion of the user, and the emotion of the robot, and inputs the text to the interaction function, thereby generating the action content of the robot.

For example, the action determination unit 236 acquires text representing the state of the robot 100 from the emotion of the robot 100 determined by the emotion determination unit 232 by using an emotion table as illustrated in Table 1. Here, in the emotion table, an index number is assigned to each emotion value for each type of emotion, and a text representing the state of the robot 100 is stored for each index number.

In a case in which the emotion of the robot 100 determined by the emotion determination unit 232 corresponds to the index number “2”, text “very pleasant state” is obtained. In a case in which the emotion of the robot 100 corresponds to a plurality of index numbers, a plurality of pieces of text representing the state of the robot 100 are obtained. An emotion table as illustrated in Table 2 is prepared for an emotion of the user 10.

Here, in a case in which the action of the user is to say “***”, the emotion of the robot 100 is the index number “2”, and the emotion of the user 10 is the index number “3”, a sentence such as “The robot is in a very pleasant state. The user is in a normally pleasant state. The user says” *** “. How do you answer as a robot?” is input to the sentence generation model to acquire the action content of the robot. The action determination unit 236 determines an action of the robot from the action content.

TABLE 1

| Index | Emotion | Emotion | |
|---|---|---|---|
| Number | Type | Value | State of Robot |
| 1 | Pleasant | 5 | Very Pleasant State |
| 2 | Pleasant | 4 | Extremely Pleasant State |
| 3 | Pleasant | 3 | Normally Pleasant State |
| 4 | Pleasant | 2 | Slightly Pleasant State |
| 5 | Pleasant | 1 | Only a Little Pleasant State |
| . . . | . . . | . . . | . . . |

TABLE 2

| Index | Type of | Emotion | |
|---|---|---|---|
| Number | Emotion | Value | State of User |
| 1 | Pleasant | 5 | Very Pleasant State |
| 2 | Pleasant | 4 | Extremely Pleasant State |
| 3 | Pleasant | 3 | Normally Pleasant State |
| 4 | Pleasant | 2 | Slightly Pleasant State |
| 5 | Pleasant | 1 | Only a Little Pleasant State |
| . . . | . . . | . . . | . . . |

As described above, since the robot 100 can change the action of the robot according to the index number corresponding to the emotion of the robot, the user has an impression that the robot has a mind, and is promoted to take an action such as talking to the robot.

The action determination unit 236 may generate the action content of the robot by adding a fixed sentence for inquiry about the action content of the robot corresponding to the action of the user and inputting the fixed sentence to the sentence generation model having the interaction function after adding not only the text representing the action of the user, the emotion of the user, and the emotion of the robot but also the text representing the content of the history data 222. As a result, the robot 100 can change the action of the robot according to the history data indicating the emotion or the action of the user, and thus, the user has an impression that the robot has personality, and is promoted to take an action such as talking to the robot. The history data may further include an emotion or an action of the robot.

The robot 100 may be mounted on a stuffed toy, or may be applied to a control device connected wirelessly or by wire to a control target device (speaker or camera) mounted on the stuffed toy.

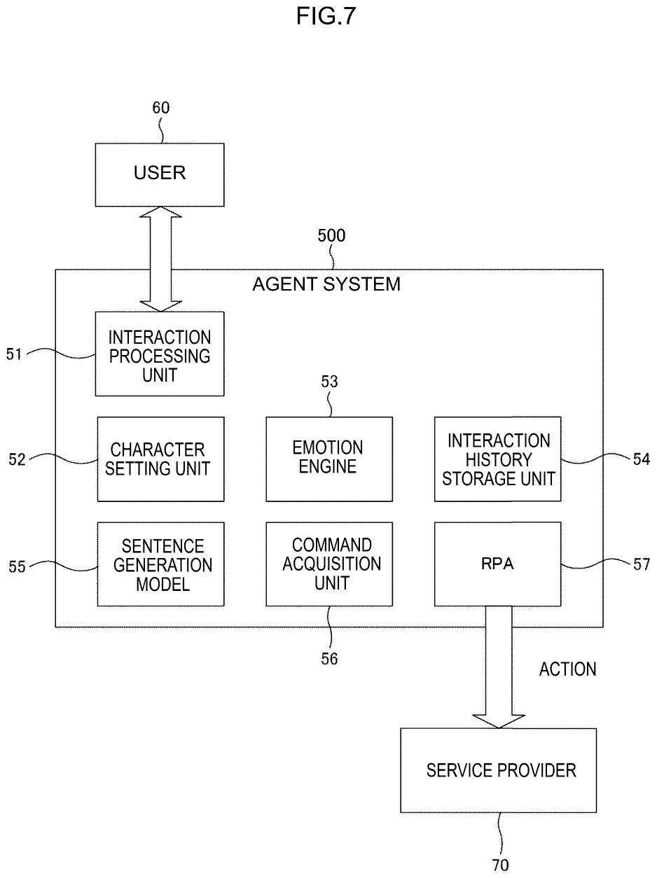

In the above description, the case in which the action control system is applied to the robot 100 has been exemplified, but the disclosure is not limited to this aspect. FIG. 7 is a functional block diagram of an agent system 500 configured by using some or all of the functions of the action control system. The agent system 500 is a computer system that performs a series of actions according to the intention of the user 60 through an interaction with the user 60. The interaction with the user 60 can be performed by vocal sound or text.

The agent system 500 can be mounted on, for example, a robot, a doll, a stuffed toy, a pendant, a smartwatch, a smartphone, a smart speaker, an earphone, or a personal computer. The agent system 500 may be implemented in a web server and used via a web browser operating on a communication terminal such as a smartphone possessed by the user.

The agent system 500 serves as, for example, a butler, a secretary, a teacher, a partner, a friend, a lover, or a teacher acting for the user 60. The agent system 500 not only interacts with the user 60 but also provides advice, guidance to a destination, recommendation according to user's preference, or the like. The agent system 500 performs reservation, order, payment, or the like on a service provider 70.

The agent system 500 includes an emotion engine 53 to determine an emotion of the user 60 and an emotion of the agent itself, and acts for the user 60 while taking into account the emotions of the user 60 and the agent. That is, the agent system 500 understands the emotion of the user 60 and reads the mood to realize heartfelt support, assistance, advice, and service provision. The agent system 500 comforts, encourages, and energizes the user by attending to the concern of the user 60. The agent system 500 plays with the user 60 and draws a picture diary to remind the user of the past. The agent system 500 performs an action that increases the sense of happiness of the user 60.

The agent system 500 includes an interaction processing unit 51, a character setting unit 52, an emotion engine 53, an interaction history storage unit 54, a sentence generation model 55, a command acquisition unit 56, and a Robotic Process Automation (RPA) 57.

The interaction processing unit 51 includes an action determination unit 236 and an action control unit 250 that perform processing related to speech. The interaction processing unit 51 generates speech content of an agent for interacting with the user 60, and outputs the speech content by at least one of vocal sound or text.

The character setting unit 52 sets a character of an agent in a case in which the agent system 500 interacts with the user 60 on the basis of designation from the user 60. That is, the speech content output from the interaction processing unit 51 is output through the agent having the set character. As the character, for example, a real celebrity or famous person such as an actor, an entertainer, an idol, or an athlete can be set. It is also possible to set a fictitious character appearing in a cartoon, a movie, or an animation. For example, it is possible to set, as the character of the agent, “Princess Anne” performed by “Audrey Hepburn” appearing in the movie “Roman Holiday”. In a case in which the agent's character is known, since the vocal sound, the wording, the tone, and the personality of the character are known, the prompt setting in the character setting unit 52 is automatically performed only by the user 60 designating his/her favorite character. The vocal sound, the wording, the tone, and the personality of the set character are reflected in the interaction with the user 60. In other words, the interaction processing unit 51 synthesizes vocal sound corresponding to the character set by the character setting unit 52, and outputs the speech content of the agent by using the synthesized vocal sound. As a result, the user 60 can feel as if he/she is interacting with his/her favorite character itself (for example, a favorite actor).

In a case in which the agent system 500 is mounted on a device having a display such as a smartphone, for example, an icon, a still image, or a moving image of an agent having a character set by the character setting unit 52 may be displayed on the display. The image of the agent is generated by using, for example, an image synthesis technology such as 3D rendering. In the agent system 500, an interaction with the user 60 may be performed while the image of the agent makes a gesture according to the emotion of the user 60, the emotion of the agent, and the speech content of the agent. The agent system 500 may output only vocal sound without outputting an image in a case of interacting with the user 60.

The emotion engine 53 includes an emotion determination unit 232, and determines an emotion value indicating the emotion of the user 60 and an emotion value of the agent itself. The emotion value of the agent itself is reflected in the emotion of the set character. In a case in which the agent system 500 interacts with the user 60, not only the emotion of the user 60 but also the emotion of the character is reflected in the interaction. That is, the interaction processing unit 51 outputs the speech content in an aspect according to the emotion determined by the emotion engine 53.

The emotion of the agent is also reflected in a case in which the agent system 500 performs an action toward the user 60. For example, in a case in which the user 60 requests the agent system 500 to take a photograph, whether or not the agent system 500 takes a photograph in response to the request of the user is determined according to the degree of the emotion of “gloomy” of the agent. In a case in which the agent has a positive emotion, the agent performs a favorable interaction or action on the user 60, and in a case in which the agent has a negative emotion, the agent performs a defiant interaction or action on the user 60.

The interaction history storage unit 54 is a storage medium for storing a history of interactions performed between the user 60 and the agent system 500. The interaction history storage unit 54 may be realized by the history data 222 of the storage unit 220 or may be realized by an external cloud storage. In the case of interacting with the user 60 or performing an action toward the user 60, the agent system 500 determines the interaction content or the action content in consideration of the content of the interaction history stored in the interaction history storage unit 54. For example, the agent system 500 ascertains the hobby and the preference of the user 60 on the basis of the interaction history stored in the interaction history storage unit 54. The agent system 500 generates interaction content matching the hobby and the preference of the user 60 and provides a recommendation. The interaction processing unit 51 generates speech content on the basis of the interaction history stored in the interaction history storage unit 54. The interaction history storage unit 54 stores personal information such as a name, an address, a telephone number, and a credit card number of the user 60 acquired through an interaction with the user 60.

The sentence generation model 55 generates a sentence that is a response to the input text or vocal sound. The sentence generation model 55 may be interpreted as an algorithm and an operation for automatic interaction processing with text. Since the sentence generation model is known as disclosed in, for example, JP-A No. 2018-081444 and chatGPT (Internet search <URL: https://openai.com/blog/chatgpt>), a detailed description thereof will be omitted. Such a sentence generation model is configured by a large language model (LLM).

The interaction processing unit 51 generates speech content on the basis of the sentence generated by the sentence generation model 55. Specifically, the interaction processing unit 51 inputs the text or vocal sound input by the user 60, the emotions of both the user 60 and the agent specified by the emotion engine 53, and the conversation history stored in the interaction history storage unit 54 to the sentence generation model 55, and generates the speech content of the agent. In this case, the interaction processing unit 51 may further input the character's personality set by the character setting unit 52 to the sentence generation model 55 to generate the speech content of the agent. In the agent system 500, the sentence generation model 55 is not located on the front-end side serving as a touch point with the user 60, but is used as a tool of the agent system 500.

The command acquisition unit 56 includes the speech understanding unit 212, and acquires an agent command from vocal sound output from the user 60 or text through an interaction with the user 60. The command includes, for example, content of actions to be executed by the agent system 500, such as information search, store reservation, ticket arrangement, purchase of products/services, payment, route guidance to a destination, and recommendation provision.

The RPA 57 performs an action according to the command acquired by the command acquisition unit 56. The RPA 57 performs actions related to use of the service provider 70, such as information search, store reservation, ticket arrangement, purchase of products/services, and payment. The RPA 57 is an example of an “operation execution unit” in the disclosure.

The RPA 57 reads the personal information of the user 60 necessary for executing the action related to the use of the service provider 70 from the interaction history storage unit 54 and uses the personal information. For example, in the case of purchasing a product in response to a request from the user 60, the agent system 500 reads and uses personal information such as a name, an address, a telephone number, and a credit card number of the user 60 stored in the interaction history storage unit 54. It is unkind to request the user 60 to input personal information in the initial setting, and it is also unpleasant for the user. In the agent system 500 according to the present embodiment, instead of requesting the user 60 to input personal information in the initial setting, the personal information acquired through the interaction with the user 60 is stored, and read and used as necessary. As a result, it is possible to avoid making the user feel unpleasant, and convenience of the user is improved.

The agent system 500 executes the interaction processing according to the following Steps 1 to 5.

(Step 1) The agent system 500 sets a character of the agent. Specifically, the character setting unit 52 sets a character of the agent in a case in which the agent system 500 interacts with the user 60 on the basis of the designation from the user 60.

(Step 2) The agent system 500 acquires the state of the user 10 including the vocal sound or text input from the user 10, the emotion value of the user 10, the emotion value of the robot 100, and the history data 222. Specifically, the processing similar to steps S100 to S103 is performed to acquire the state of the user 10 including the vocal sound or text input from the user 10, the emotion value of the user 10, the emotion value of the robot 100, and the history data 222.

(Step 3) The agent system 500 determines speech content of the agent. Specifically, the interaction processing unit 51 inputs the text or vocal sound input by the user 60, the emotions of both the user 60 and the character specified by the emotion engine 53, and the history of conversations stored in the interaction history storage unit 54 to the sentence generation model 55, and generates the speech content of the agent.

For example, a fixed sentence “In this case, how do you answer as an agent?” is added to the text or vocal sound input by the user 60 and the text representing the emotions of both the user 60 and the character specified by the emotion engine 53 and the conversation history stored in the interaction history storage unit 54, and the text is input to the sentence generation model 55 to acquire the speech content of the agent.

As an example, in a case in which the text or the vocal sound input by the user 60 is “I need a reservation at 7 μm at a good Chinese restaurant nearby.”, “Understood.”, and “These are recommended restaurants. 1.AAAA. 2.BBBB. 3.CCCC. 4.DDDD” are acquired as speech content.

In a case in which the text or the vocal sound input by the user 60 is “Fourth DDDD is good”, “Understood. I will make a reservation. How many seats do you need?” are acquired as speech content.

(Step 4) The agent system 500 outputs the speech content of the agent. Specifically, the interaction processing unit 51 synthesizes vocal sound corresponding to the character set by the character setting unit 52, and outputs the speech content of the agent by using the synthesized vocal sound.

(Step 5) The agent system 500 determines whether or not a timing to execute a command of the agent has arrived. Specifically, the interaction processing unit 51 determines whether or not the timing to execute the command of the agent has arrived on the basis of the output of the sentence generation model 55. For example, in a case in which the output of the sentence generation model includes that the agent executes the command, it is determined that the timing to execute the command of the agent has arrived, and the processing proceeds to Step 5. On the other hand, in a case in which it is determined that it is not the timing to execute the command of the agent, the processing returns to Step 2 described above.

(Step 6) The agent system 500 executes the command of the agent. Specifically, the command acquisition unit 56 acquires the command of the agent from the vocal sound output from the user 60 or the text through an interaction with the user 60. The RPA 57 performs an action corresponding to the command acquired by the command acquisition unit 56. For example, in a case in which the command is “information search”, information search is performed by a search site by using a search query obtained through an interaction with the user 60 and an application programming interface (API). The interaction processing unit 51 inputs the search result to the sentence generation model 55 and generates the speech content of the agent. The interaction processing unit 51 synthesizes vocal sound corresponding to the character set by the character setting unit 52, and outputs the speech content of the agent by using the synthesized vocal sound.

In a case in which the command is “store reservation”, the reservation is made by making a phone call to the reservation destination store through phone software by using the reservation information obtained through the interaction with the user 60, the reservation destination store information, and the application programming interface (API). In this case, the interaction processing unit 51 acquires the speech content of the agent with respect to the vocal sound input from the other party by using the sentence generation model having the interaction function. The interaction processing unit 51 inputs the result of the store reservation (whether or not the reservation was successful) to the sentence generation model 55, and generates the speech content of the agent. The interaction processing unit 51 synthesizes vocal sound corresponding to the character set by the character setting unit 52, and outputs the speech content of the agent by using the synthesized vocal sound. The processing returns to Step 2 described above.

As described above, the agent system 500 can execute interaction processing and perform an action related to use of the service provider 70 as necessary. While the user is sleeping, the agent system 500 may search for news or the like that the user is interested in on the basis of the taste of the user acquired in advance, and in a case in which the user wakes up, the agent system 500 may deliver the news from itself. For example, the agent says “The Yankees seems to have won the game yesterday. Let's go to the baseball park to cheer on this evening.” In a case in which the user says “I need to consult my father”, the father says “I doubt whether a ticket can be obtained”. The agent says “I will check whether a ticket can be obtained”, and the request for a seat or the like is interrogated from an interaction with the user to secure a ticket.

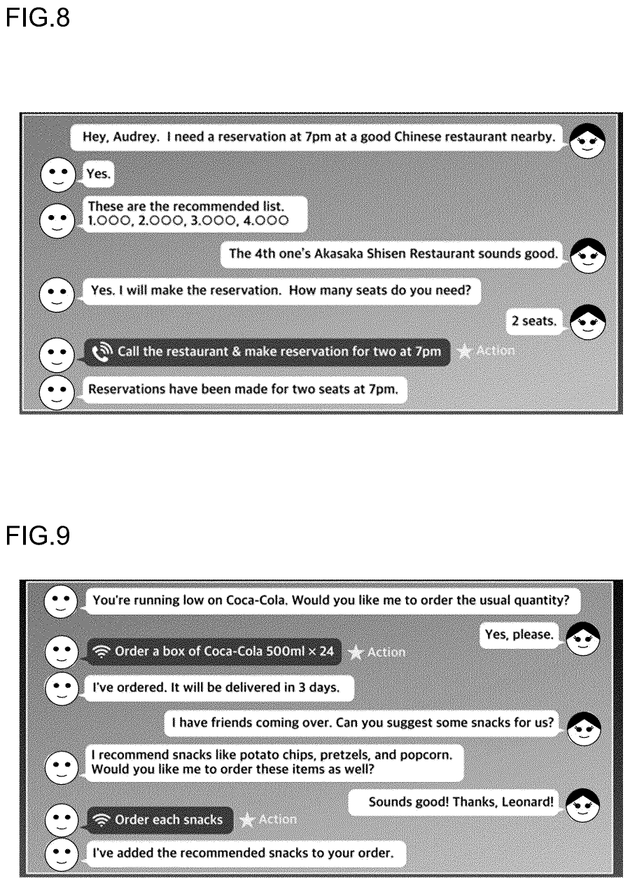

FIGS. 8 and 9 are diagrams illustrating an example of the operation of the agent system 500. FIG. 8 illustrates an aspect in which the agent system 500 makes a restaurant reservation through an interaction with the user 60. The agent system 500 can ascertain a preference of the user 60 based on an interaction history with the user 60, provide a recommendation list of restaurants that match the preference of the user 60, and perform a reservation of a selected restaurant.

On the other hand, FIG. 9 illustrates an aspect in which the agent system 500 accesses a mail order site through an interaction with the user 60 to purchase a product. The agent system 500 can estimate a remaining amount of the beverage stocked by the user on the basis of the interaction history with the user 60, and can propose and execute the purchase of the beverage to the user 60. The agent system 500 can ascertain the taste of the user on the basis of the past interaction history with the user 60, and recommend a snack that the user likes.

### Second Embodiment

A second embodiment is characterized in that the agent system 500 newly creates an agent imitating the user 60.

Hereinafter, differences from the first embodiment will be described. The same constituents are denoted by the same reference numerals, and a detailed description thereof will be omitted.

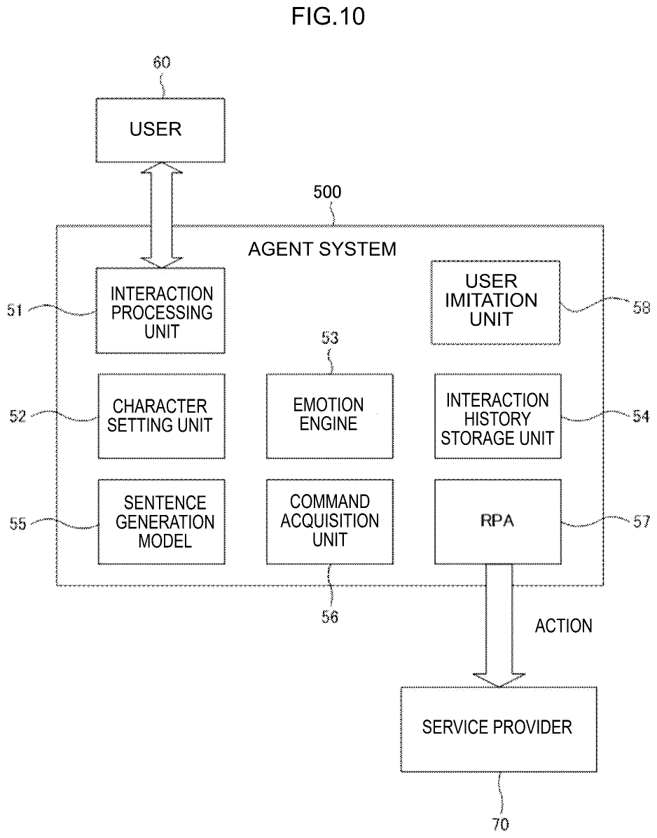

As illustrated in FIG. 10, the agent system 500 further includes a user imitation unit 58.

The user imitation unit 58 imitates the user 60 and creates an agent reflecting features of the user 60. Specifically, the user imitation unit 58 acquires the interaction history of the user 60, the action history, and the attribute information of the user 60 from the interaction history storage unit 54 as input data, and creates an agent reflecting the features of the user 60. The user imitation unit 58 creates an agent imitating the user 60 by using data of emotions of the user 60 determined by the emotion determination unit 232. The interaction history storage unit 54 may be realized by the history data 222 of the storage unit 220 or may be realized by an external cloud storage. The history data 222 of the storage unit 220 includes a history of past emotion values and actions of the user 60.

The character setting unit 52 can newly set a character called the user 60 by fetching the data of the created agent. The user 60 can select one agent from a plurality of types in character setting.

Therefore, an agent that is a virtual self of the user 60 is created. Hereinafter, the imitation agent created by imitating the user 60 will be referred to as an “agent U”, and the other agents will be referred to as “agents A”.

The created agent U can repeat an interaction with the agent A.

Specifically, after the user 60 asks the agent A a question, the agent U asks the agent A a question to assist the user.

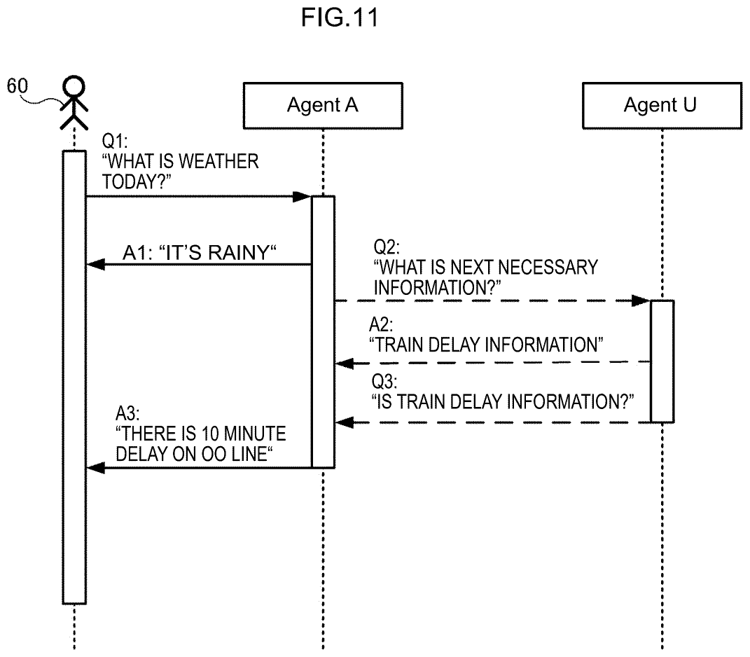

More specifically, a description will be made with reference to FIG. 11. FIG. 11 is a diagram illustrating interactions between the user 60, the agent A, and the agent U in chronological order. The upper left is the starting point. The user 60 cannot check the interaction content indicated by the dashed arrow in FIG. 11, that is, the interaction content between the agent A and the agent U. The content of the interaction is an example, and is not limited thereto.

FIG. 11 will be described in chronological order. First, in a case in which the user 60 asks the agent A a question “What is the weather today?”, the agent A answers “It's rainy”. The agent A asks the agent U a question such as “What is the next necessary information?”. The agent U presents a category of the next necessary information in advance, and asks the agent A a question about the information. For example, the agent U answers “(The next necessary information is) train delay information”, and the agent U further asks the agent A a question such as “Is train delay information?”. On the other hand, the agent A answers the user 60 that “there is a delay of 10 minutes on the OO line”. As described above, the user 60 can obtain not only the weather information but also the train delay information only by the user 60 asking a question about the today's weather.

Here, the interaction between the agent U and the agent A is performed as back-side processing that is not recognized by the user 60. That is, the interaction is not visible to the user 60, and is not required to be checked by the user 60. The agent U asks a question or the like to the agent A instead of the user 60.

As a result, there is an effect that the user 60 feels that the agent A is responding by ascertaining the feeling of the user 60. In other words, the agent U can function even in a place where the agent U cannot be checked by the user 60, and the agent U searches for information in advance, so that it is possible to pretend that the agent A is considerate.

Therefore, since the agent U continues to ask a question to the agent A instead of the user 60 by only asking the first question of the user 60 to the agent A, the user 60 can acquire desired information only by waiting.

As described above, the interaction of the user 60 with the agent A is used as a trigger, and the agent U interacts with the agent A to assist the user 60.

The trigger need not be the interaction of the user 60. The agent U may acquire a state of the user 60 and the agent U may start the interaction with the agent A. The user state recognition unit 230 recognizes the state of the user 60. For example, the user state recognition unit 230 can recognize a state in which the user 60 seems to be bored alone. The agent U acquires a result recognized by the user state recognition unit 230.

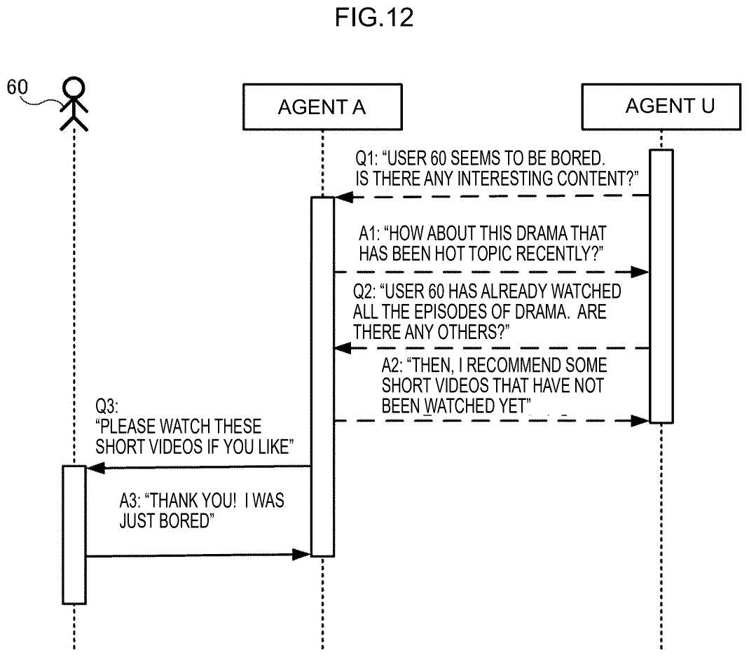

FIG. 12 is a diagram illustrating an example in which the agent U acquires the state of the user 60 and the agent U and the agent A interact with each other. The upper right is the starting point. The user 60 cannot check the interaction content indicated by the dashed arrow in FIG. 12, that is, the interaction content between the agent A and the agent U. The content of the interaction is an example, and is not limited thereto.

FIG. 12 will be described in chronological order. First, the agent U acquires the state of the user 60, and recognizes that the user 60 seems to be bored alone. The agent U notifies the agent A of the fact. For example, the agent U says to the agent A, “The user 60 seems to be bored. Is there any interesting content?”. The agent A makes a proposal such as “How about this drama that has been a hot topic recently?” On the other hand, the agent U searches for the interaction history or the action history of the user 60 and considers the preference of the user, and says to the agent A such as “The user 60 has already watched all the episodes of the drama. Are there any other?”. The agent A answers, “Then, I recommend some short videos that have not been watched yet”. The agent A proposes to the user 60 “Please watch these short videos if you like”. The user 60 interacts with the agent A, saying “Thank you! I was just bored”.

As described above, even in a case in which the user 60 does not take any action, the agent U can interact with the agent A on the back side. Since the agent U acquires the state of the user and interacts with the agent A, the agent A can make a proposal according to the state of the user.

The agent U is updated daily on the basis of the interaction history between the user 60 and the agent A. This update increases the degree of imitation of the agent U with respect to the user 60. The feedback is input to the agent U such that the agent U is updated, on the basis of not only the interaction history but also the emotion value of the user 60 associated with the interaction history. For example, the agent U acquires an interaction history in which the user 60 has had an interaction with the agent A with a gloomy feeling of “This cartoon was boring” and information of an emotion value (“sad”: 3) of the user 60. The agent U learns the information as an input to increase the degree of imitation for the user 60.

The user imitation unit 58 can also add adjustment to the agent U created by imitating the user 60, in response to an instruction of the user 60.

In a case in which a different opinion occurs between the user 60 and the agent U, in principle, the opinion of the user 60 can be respected, and in a case in which danger or damage occurs to the user 60, the opinion of the agent U can be respected. The agent U predicts that the user 60 will ask a question about such a thing, and executes a question to the agent A, information search on a web, and the like. The agent U may speak on behalf of the user 60.

The agent U also reproduces the tension of the user 60. Specifically, in a case in which the user 60 is asking a question with a dark emotion in the case of asking a question to the agent A, the agent U also maintains a low tension and continues to ask a question to the agent A. At the same time, the agent U adjusts the content of the question.

In a case in which the user 60 looks pleasant, the agent U not only imitates the high tension but also reflects the high tension in the content of the question. As described above, since the agent U adjusts the tension and the content in accordance with the emotion of the user 60 and asks the agent A a question, the user 60 easily feels comfortable.

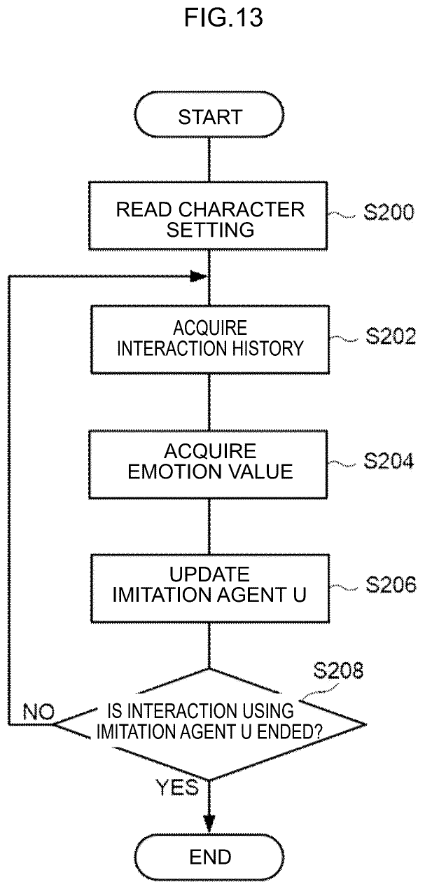

Hereinafter, an operation of the agent system 500 according to the present embodiment will be described. In the agent system 500, user imitation processing illustrated in FIG. 13 is executed. The processing in the agent system 500 is executed by the CPU 1212 functioning as the user imitation unit 58 and the character setting unit 52.

FIG. 13 is a flowchart illustrating the user imitation processing of the agent system 500.

The CPU 1212 repeatedly executes the flowchart illustrated in FIG. 13.

First, in step S200, the CPU 1212 reads a character setting. Here, it is assumed that a character called the agent U is newly added.

In step S202, the CPU 1212 acquires an interaction history. Specifically, the CPU 1212 acquires the interaction history, the action history, and the attribute information of the user 60 stored in the interaction history storage unit 54.

In step S204, the CPU 1212 acquires the emotion value of the user 60. This emotion value is associated with the interaction history.

In step S206, the CPU 1212 updates the imitation agent U by using the acquired data.

In step S208, the CPU 1212 determines whether or not the imitation agent U ends the interaction with the agent A. The case in which the imitation agent U ends the interaction with the agent A is a case in which the user 60 determines that it is unnecessary to complement the interaction with the agent A by the imitation agent U. In a case in which the CPU 1212 determines that the imitation agent U does not end the interaction with the agent A (step S208: NO), the processing returns to step S202. On the other hand, in a case in which the CPU 1212 determines that the imitation agent U ends the interaction with the agent A (step S208: YES), the user imitation processing is ended.

### Summary of Second Embodiment

Since the agent U automatically interacting with the agent A is to execute a task without setting an action from the user 60 as a start point, an action of the user 60 such as speech can be reduced.

Setting of tuning or the like of the interaction content with respect to the agent by the user 60 is also unnecessary, and the agent U autonomously interacts and acts as if the user 60 himself/herself is speaking. Since the agent U imitates the user 60 not only from the interaction history of the user but also the action history, the agent U can present a favorite store of the user 60 or the like to the agent A with high priority. The agent U acquires information that meets the needs of the user 60 without the user 60 asking a question. The acquired information is delivered from the agent U to the agent A and is then delivered from the agent A to the user 60.

The agent U can maintain the imitation degree for the user 60 by not only being updated daily but also being constantly updated on the basis of the interaction history or the like in accordance with the change in preference or the emotion value of the user 60.

### Third Embodiment

A third embodiment is characterized in that a user other than the user 60 can access the agent U created by imitating the user 60 in the agent system 500, and another user interacts with the agent U.

Hereinafter, differences from the second embodiment will be described. The same constituents are denoted by the same reference numerals, and a detailed description thereof will be omitted.

The agent system 500 is configured by using some or all of the functions of the action control system. An application target of the action control system is not limited to the robot 100, and the action control system can be applied to various electronic apparatuses.

As the user 60 speaks to the agent A created in the agent system 500, a user other than the user 60 (hereinafter, the “other person X” is set, and another person X1, another person X2, . . . are set in a case in which there are a plurality of other persons X) can speak to the agent U. The other person X corresponds to another user. The agent U can distinguish the imitation source user 60 from another user through vocal sound recognition or the like.

The other person X can acquire the information regarding the user 60 by talking to the agent U imitating the user 60. The other person X can interact with the user 60 in a pseudo manner by interacting with the agent U. The other person X can ascertain the latest information regarding the user 60 by interacting with the agent U. The other person X can acquire the information regarding the user 60 by two-way communication in an interactive manner with the agent U.

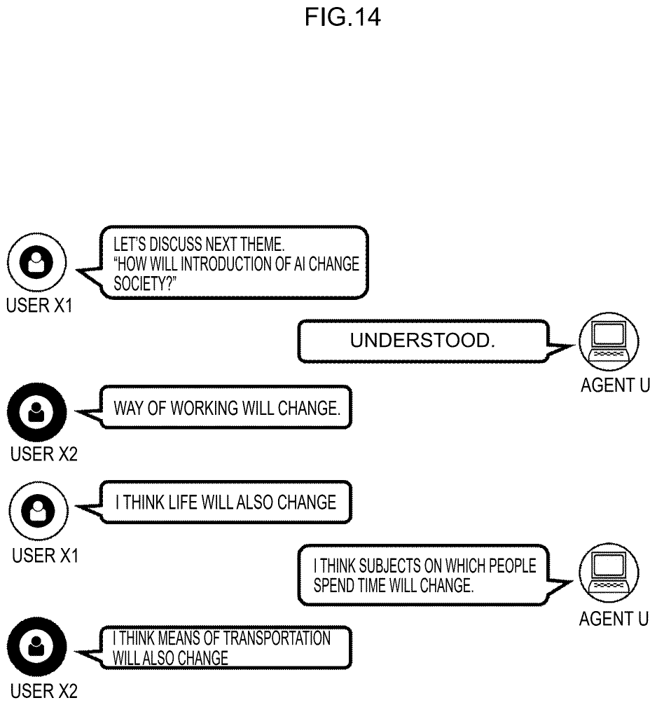

The agent U imitating the user 60 and the other person X1 and the other person X2 may have a discussion. FIG. 14 is a diagram illustrating a state of discussion. The content of the discussion is an example, and is not limited thereto. A user X1 and a user X2 in FIG. 14 are another person X1 and another person X2.

Specifically, for example, the user X1 says to the agent U, “Let's discuss the next theme. In the case of proposing “How will the introduction of AI change society?”, the agent U says “Understood”. The discussion actually starts, and the user X2 says “I think the way of working will change” or the user X1 says “I think life will also change”. The agent U acquires the speech content of the user 60 from the past interaction history and argues, for example, “I think a subject on which a person spends time will change”. The discussion continues with the user X2 saying “I think the means of transportation will also change”. The agent U acquires and discusses the information regarding the user 60 and the speech content held by the agent U with respect to the sentence thrown by another person X1 or another person X2. The series of discussions may be vocal sound interaction as well as interaction such as text-based chat. The number of participants in the discussion is not limited to the example in FIG. 14.

The agent U records the discussion between another person X1 and another person X2. For example, the interaction processing unit 51 may function as a generation unit that generates meeting minutes or the like. The agent U of the present embodiment can take meeting minutes while participating in a discussion with another person X.

As described above, the agent U virtually has a discussion with a plurality of other persons X, whereby the user 60 can easily obtain only the discussion result (meeting minutes) without taking time for the discussion. Although another person X1 and another person X2 are users (humans) in the above-described example, the other persons X1 and X2 may also be agents imitating the respective users.

### Fourth Embodiment

A fourth embodiment is characterized in that a plurality of agents created by the agent system 500 appear and the users 60 or the agents interact with each other.

Hereinafter, differences from the first embodiment will be described. The same constituents are denoted by the same reference numerals, and a detailed description thereof will be omitted.

Here, the sentence generation model 55 such as chatGPT may have different answers (outputs) even if the same question (input) is asked. By using the feature, in the present embodiment, a plurality of agents are caused to give a plurality of answers to the same question.

Specifically, in a case in which the user 60 asks a question, a plurality of agents answer the question. At that time, in order not to give the same answer, for example, setting may be made such that not only the input of the question sentence of the user 60 but also the input of an instruction for avoiding the same answer are added to a prompt that is the input of the sentence generation model 55, and the same answer is not shown. The number of agents to give answers is not limited. The appearance of a plurality of agents at the same time enables the user 60 to obtain various opinions from the plurality of agents. Messages can be obtained with various tones and expression methods even in the same opinion.

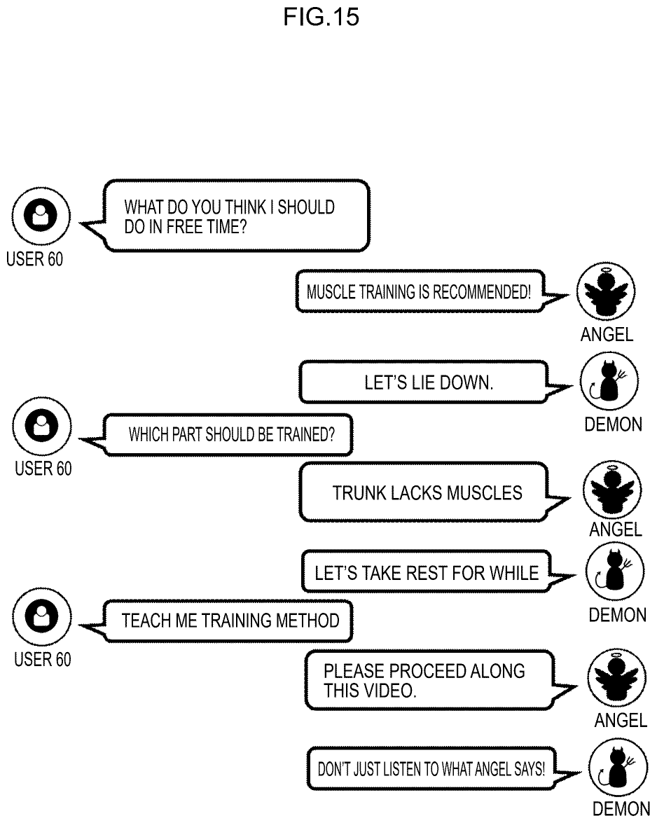

Specifically, in the character setting unit 52, for example, it is possible to widen the range of answers of the agent by adding characters such as a critic, a standup comedy duo, an idol group, an angel and a demon. An interaction can be exchanged between agents having the set characters. Adding the emotion of the agent estimated by the emotion engine to the interaction between the agents further enhances the content of the interaction. As an example, FIG. 15 illustrates answers of a plurality of agents.

As illustrated in FIG. 15, the user 60 asks a question “What do you think I should do in free time?”, and as an answer, an agent set with the character of an angel answers “Muscle training is recommended!”, while an agent set with the character of a demon answers “Let's lie down”. In response to these answers, the user 60 asks a question “Which part should be trained?”, and as an answer, the agent of the angel answers “You do not have enough muscles of the trunk”, while the agent of the demon answers “Let's take a rest for a while”. In a case in which the user 60 says “Teach me a training method”, the agent of the angel answers “Please proceed along this video”, and the agent of the demon becomes jealously displeased and becomes angry “Don't listen to the angel's words!” in a case in which only the answer content of the agent of the angel is selected by the user 60. As described above, the agent can give an answer according to the agent's emotion.

As described above, not only the agent can generate an answer to the user's input, but also the other agent can generate an answer on the basis of the answer of one agent, that is, the agents can interact with each other. Since each agent has an emotion, the content of the interaction also changes according to the emotion. The type of emotion in the emotion map 400 is mainly selected first.

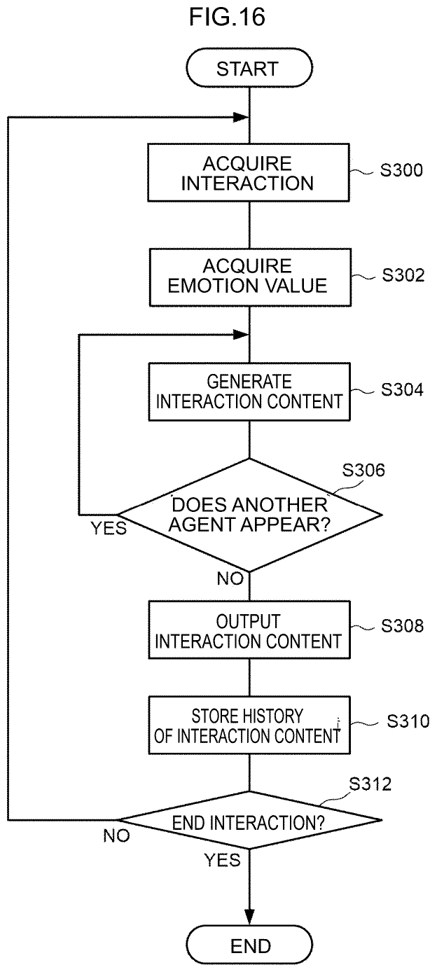

Next, an operation of the agent system 500 according to the present embodiment will be described. In the agent system 500, interaction processing of a plurality of agents illustrated in FIG. 16 is executed. Each type of processing in the agent system 500 is executed by the CPU 1212 functioning as the interaction processing unit 51, the character setting unit 52, the emotion engine 53, and the interaction history storage unit 54. The interaction processing is repeatedly executed in the case of continuing the interaction.

The interaction processing will be described with reference to FIG. 16.

In step S300, the CPU 1212 acquires the interaction of the user 60 or the agent. The interaction may be vocal sound or text. Not only the interaction currently in progress but also the past interaction is acquired. The past interaction can be acquired from the conversation history stored in the interaction history storage unit 54.

In step S302, the CPU 1212 acquires the state of the user 60 including the vocal sound or text input from the user 60 or the agent, the emotion value of the user 60, the emotion value of the agent, and the history data 222. Specifically, processing similar to that in steps S100 to S103 described above is performed to acquire the state of the user 60 including the vocal sound or text input from the user 60, the emotion value of the user 60, the emotion value of the agent, and the history data 222.

In step S304, the CPU 1212 generates interaction content of the agent. Specifically, the interaction processing unit 51 inputs the text or vocal sound input by the user 60 and the agent, the emotions of the user 60 and the agent specified by the emotion engine 53, the conversation history stored in the interaction history storage unit 54, and the character setting conditions to the sentence generation model 55 to generate the interaction content of the agent. As a result, the interaction content of the tone or expression according to the set character setting is generated. In a case in which the user 60 has not set a character, any character may be automatically set to the agent.

In step S306, the CPU 1212 determines whether or not another agent appears in the interaction. That is, in a case in which a plurality of agents appear in the interaction, it is determined that there is another agent that has not generated the interaction content in step S304. In a case in which the CPU 1212 determines that another agent appears (step S306: YES), the processing proceeds to step S304. On the other hand, in a case in which the CPU 1212 determines that no other agent appears (step S306: NO), the processing proceeds to step S308. As a result, generation of the interaction content of step S304 is repeated as many times as the number of agents appearing in the interaction. Therefore, the agent system 500 can generate a plurality of answers. For example, in a case in which the character of the angel and the character of the demon are set, a condition of an instruction “Please give an answer as an angel” is input to the input of the sentence generation model 55 in step S304, and a condition of an instruction “Please give an answer as a demon” is input to the input of the sentence generation model 55 in second step S304. The interaction content generated in step S304 is stored separately without being overwritten. As a result, for example, it is possible to generate the answer of the angel and the answer of the demon.

In step S308, the CPU 1212 outputs interaction content of the plurality of agents. Specifically, the interaction processing unit 51 can synthesize vocal sound corresponding to the character set by the character setting unit 52 and output the interaction content of the agent by using the synthesized vocal sound. The interaction content may be output by using text instead of vocal sound. The interaction content is output for each set character.

In step S310, the CPU 1212 stores a history of interaction content between the user 60 and a plurality of agents or between the agents. Specifically, the interaction content is stored in the interaction history storage unit 54.

In step S312, the CPU 1212 determines whether or not to end the interaction. The case of ending the interaction is a case in which the user 60 indicates a final sign or interaction, a case in which a conclusion is made by an interaction between agents, or the like. In a case in which the CPU 1212 determines to end the interaction (step S312: YES), the interaction processing is ended. On the other hand, in a case in which the CPU 1212 determines not to end the interaction (step S312: NO), the processing proceeds to step S300. In that case, new interaction content is generated on the basis of the interaction content output in step S308. That is, the interaction continues while the determination in step S312 is NO.

Not only the agent answers the question of the user 60 and another agent answers the answer, but also the user 60 may cause the agents to have a discussion in a case in which the user 60 wants to see the play between the agents even if there is no question from the user. In that case, the interaction content of each agent is input to the sentence generation model 55 in step S304 as described above.

The user 60 may provide a theme and cause agents having different character settings to have a discussion, and the user 60 may acquire a conclusion or the like. The user 60 can obtain a discussion result regarding the presented theme even if the user does not participate in the interaction. For example, the interaction processing unit 51 may record a discussion, and the interaction processing unit 51 may generate meeting minutes. Specifically, after the interaction content is output in step S308, the history of the interaction content is stored in the interaction history storage unit 54 in step S310, so that the interaction processing unit 51 can generate the meeting minutes by using the data.

As described above, by causing a plurality of agents to think and make a conclusion, it is possible to acquire an examined answer compared with the case of causing one agent to give an answer. The plurality of agents caused to have a discussion may be an agent imitating the user 60 and an agent imitating another person. By causing the agents imitating the respective users to have a discussion, there is an advantage that it is possible to reduce the time and effort for the user to participate and easily obtain a discussion result. The user can be entertained by a play between agents.

The agent can supplement an answer of the agent with an answer of another agent. Specifically, in a case in which an answer generated by the agent becomes long or includes a technical term, another agent makes a quick response at an appropriate timing, asks a question about the technical term, or rephrases a difficult expression. Another agent may play a role of explaining the answer basis of the agent. As a result, the content of the answer to the user can be enriched and reliability can be improved.

Hereinafter, exemplary embodiments of a data processing apparatus, a data processing method, and a data processing program according to the technology of the disclosure will be described with reference to the accompanying drawings.

First, words used in the following description will be described.

In the following embodiments, the signed processor (hereinafter, simply referred to as a “processor”) may be one arithmetic device or a combination of a plurality of arithmetic devices. The processor may be one type of arithmetic device or a combination of a plurality of types of arithmetic devices. Examples of the arithmetic device include a central processing unit (CPU), a graphics processing unit (GPU), general-purpose computing on graphics processing units (GPGPUs), an accelerated processing unit (APU), a tensor processing unit (TPU), or the like.

In the following embodiments, a signed random access memory (RAM) is a memory in which information is temporarily stored, and is used as a work memory by the processor.

In the following embodiments, the signed storage is one or more nonvolatile storage devices that store various programs, various parameters, and the like. Examples of the nonvolatile storage device include a flash memory (solid state drive (SSD)), a magnetic disk (for example, a hard disk), and a magnetic tape.

In the following embodiments, the signed communication interface (I/F) is an interface including a communication processor, an antenna, and the like. The communication I/F manages communication between a plurality of computers. Examples of the communication standard applied to the communication I/F include wireless communication standards including 5G (5th Generation Mobile Communication System), Wi-Fi (registered trademark), and Bluetooth (registered trademark).

In the following embodiments, “A and/or B” is synonymous with “at least one of A and B”. That is, “A and/or B” means only A, only B, or a combination of A and B. In the present specification, the same concept as “A and/or B” is applied also in a case in which three or more matters are combined and expressed by “and/or”.

### Fifth Embodiment

Next, a fifth embodiment of the data processing system 1000 according to the embodiment will be described.

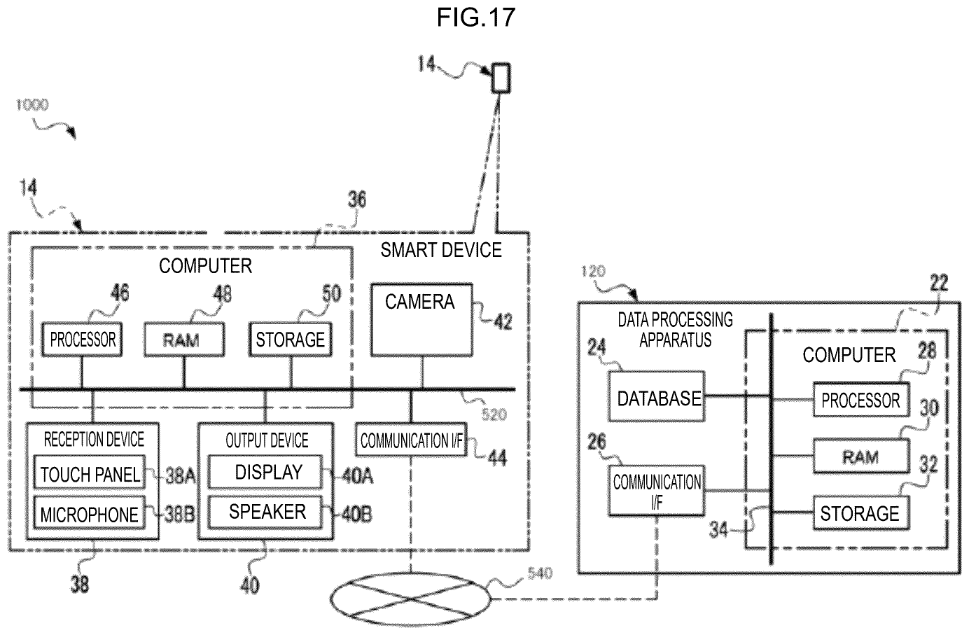

FIG. 17 illustrates an example of a configuration of a data processing system 1000 according to the embodiment.

As illustrated in FIG. 17, the data processing system 1000 includes a data processing apparatus 120 and a smart device 14. An example of the data processing apparatus 120 is a server. An example of the smart device 14 is a smartphone. In the present embodiment, the data processing apparatus 120 is an example of a “data processing apparatus” according to the technology of the disclosure, and the smart device 14 is an example of an “electronic apparatus” according to the technology of the disclosure.

The data processing apparatus 120 includes a computer 22, a database 24, and a communication I/F 26. The computer 22 is an example of a “computer” according to the technology of the disclosure. The computer 22 includes a processor 28, a RAM 30, and a storage 32. The processor 28, the RAM 30, and the storage 32 are connected to a bus 34. The database 24 and the communication I/F26 are also connected to the bus 34. The communication I/F 26 is connected to a network 540. Examples of the network 540 include a wide area network (WAN) and/or a local area network (LAN).

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 520. The reception device 38, the output device 40, and the camera 42 are also connected to the bus 520.

The reception device 38 includes a touch panel 38A, a microphone 38B, and the like, and receives a user input. The touch panel 38A detects contact of an indicator (for example, a pen or a finger) to receive a user input through the contact of the indicator. The microphone 38B receives a user input by vocal sound by detecting the vocal sound of the user. A control unit 46A transmits input data indicating the user input received by the touch panel 38A and the microphone 38B to the data processing apparatus 120. In the data processing apparatus 120, a specific processing unit 290 acquires the input data indicating the user input.

The output device 40 includes a display 40A, a speaker 40B, and the like, and presents data to a user by outputting the data in an expression (for example, vocal sound and/or text) perceptible by a human user. The display 40A displays visible information such as text and images in response to an instruction from the processor 46. The speaker 40B outputs vocal sound in accordance with an instruction from the processor 46. The camera 42 is a small digital camera on which an optical system such as a lens, a diaphragm, and a shutter and an imaging element such as a complementary metal-oxide-semiconductor (CMOS) image sensor or a charge coupled device (CCD) image sensor are mounted.

The communication I/F 44 is connected to the network 540. The communication I/F 44 and the communication I/F 26 manage exchange of various types of information between the processor 46 and the processor 28 via the network 540.

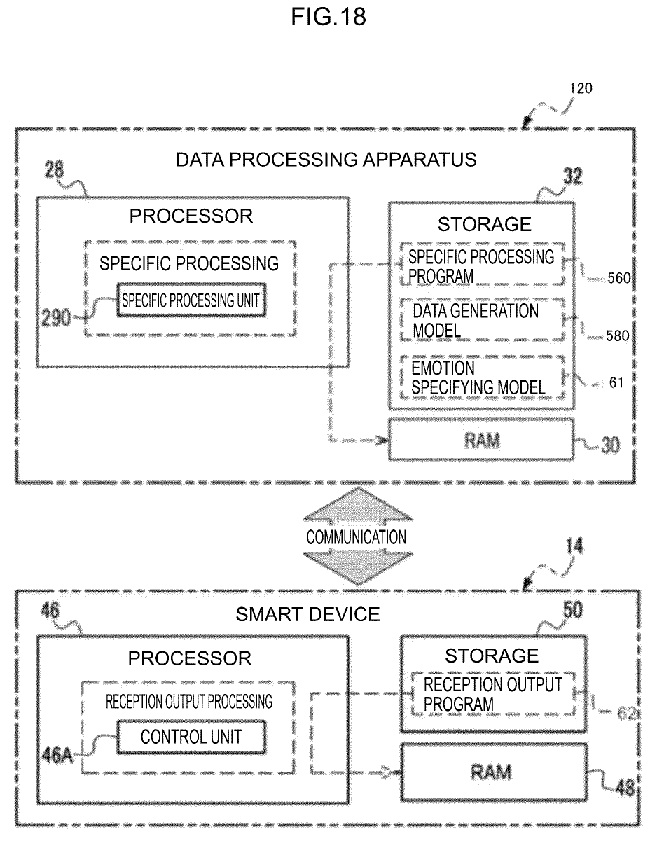

FIG. 18 illustrates an example of main part functions of the data processing apparatus 120 and the smart device 14.

As illustrated in FIG. 18, in the data processing apparatus 120, specific processing is performed by the processor 28. The storage 32 stores a specific processing program 560. The specific processing program 560 is an example of a “data processing program” according to the technology of the disclosure. The processor 28 reads the specific processing program 560 from the storage 32 and executes the read specific processing program 560 on the RAM 30. The specific processing is realized by the processor 28 operating as the specific processing unit 290 according to the specific processing program 560 executed on the RAM 30.

The storage 32 stores a data generation model 580 and an emotion specifying model 61. The data generation model 580 and the emotion specifying model 61 are used by the specific processing unit 290.

In the smart device 14, reception output processing is performed by the processor 46. The storage 50 stores a reception output program 62. The reception output program 62 is used in combination with the specific processing program 560 by the data processing system 1000. The processor 46 reads the reception output program 62 from the storage 50 and executes the read reception output program 62 on the RAM 48. The reception output processing is realized by the processor 46 operating as the control unit 46A according to the reception output program 62 executed on the RAM 48.

Here, the smart device 14 has installed therein an application (hereinafter, a “specific application”) capable of posting a created sentence that is a sentence created by a posting user and capable of viewing the created sentence as a viewing user. Among users of the smart device 14, a posting user who posts the created sentence can post the created sentence by executing the specific application and performing a predetermined operation. Among the users of the smart device 14, a viewing user who views the created sentence can view the created sentence by executing the specific application and performing a predetermined operation. Examples of the created sentence include descriptive sentences such as an explanatory sentence, an argumentative sentence, and a critical sentence, and literary sentences such as a narrative sentence, an essay sentence, and poetry. The posting user is an example of a “first user” according to the technology of the disclosure, and the viewing user is an example of a “second user” according to the technology of the disclosure.

The data processing apparatus 120 stores the created sentence posted by the posting user in the database 24. The data processing apparatus 120 acquires the created sentence based on a search query input to the specific application from the database 24, and outputs the created sentence to the smart device 14 of the viewing user who has input the search query. The database 24 is an example of a “storage unit” according to the technology of the disclosure.

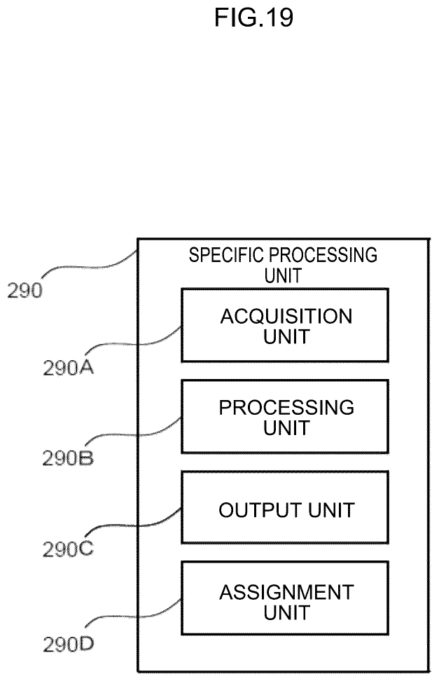

Next, processing of the specific processing unit 290 in a case in which the data processing apparatus 120 performs specific processing of generating information according to input data indicating a user input will be described. FIG. 19 is a first block diagram illustrating an example of a functional configuration of the specific processing unit 290.

As illustrated in FIG. 19, the specific processing unit 290 includes an acquisition unit 290A, a processing unit 290B, an output unit 290C, and an assignment unit 290D.

The acquisition unit 290A acquires input data indicating the user input received by the smart device 14. Specifically, the acquisition unit 290A acquires input data based on text input, vocal sound input, and the like of the user received by the smart device 14. The acquisition unit 290A acquires a created sentence created by the posting user as input data.

The processing unit 290B performs specific processing using the data generation model 580. The data generation model 580 is so-called generative artificial intelligence (AI). Examples of the data generation model 580 include generative AI such as ChatGPT. Since ChatGPT is known as disclosed in, for example, Internet search <URL: https://openai.com/blog/chatgpt>, Internet search <URL: https://aismiley.co.jp/ai_news/chatgpt-tsukattemita/>, and the like, a detailed description thereof will be omitted.

The data generation model 580 is obtained by causing the neural network to perform deep learning. To the data generation model 580, a prompt including an instruction is input, and inference data such as vocal sound data indicating vocal sound, text data indicating text, and image data indicating an image is input. The data generation model 580 infers the input inference data according to the instruction indicated by the prompt, and outputs an inference result in data formats such as vocal sound data, text data, and image data. Here, the inference indicates, for example, analysis, classification, prediction, and/or summary. The data generation model 580 is an example of a “generation model” according to the technology of the disclosure.

The above specific processing includes first specific processing of generating a task that can be solved by the content of the created sentence as information corresponding to the input data and a key point of the created sentence, second specific processing of generating a search intention of the viewing user assumed from the search query as the information, and third specific processing of generating a list of key points associated with the task corresponding to the search intention. The above task can solve predetermined problems that humans have, such as relieving fatigue, relieving pain, losing weight, and building muscles. The above key point includes at least one of a title and a summary of a created sentence. Hereinafter, as an example, the key point of the created sentence will be described as a “title of the created sentence”.

The processing unit 290B inputs a prompt including the created sentence acquired by the acquisition unit 290A, a task that can be solved by the content of the created sentence, and an instruction for generating a title of the created sentence to the data generation model 580 as the first prompt, and generates a task and a title corresponding to the first prompt.

The processing unit 290B stores the generated task and title corresponding to the first prompt, the created sentence that is the basis of the task and the title, and the posting user who has created the created sentence in the database 24 in association with each other. As a result, each created sentence is associated with a task, a title, and a posting user who has created the created sentence. The processing unit 290B fine-tunes the data generation model 580 by using the generated pair of the task and the title corresponding to the first prompt as learning data. For example, the processing unit 290B performs fine tuning of the data generation model 580 as appropriate by using a known method disclosed in Internet search <URL: https://www.brainpad.co.jp/doors/knowledge/01_chatgpt_fine_tuning_internal_documents/>, Internet search <URL: https://di-acc2.com/programming/python/25924/>, or the like.

The processing unit 290B inputs a prompt including the search query acquired by the acquisition unit 290A as input data and an instruction for inquiring about the search intention of the viewing user assumed from the search query to the data generation model 580 as the second prompt, and generates the search intention corresponding to the second prompt. The search query is a phrase input to the specific application by the viewing user, and in the present embodiment, the search query is a “sentence”. The search intention is the purpose of the viewing user assumed from the search query, such as wanting to relieve fatigue, relieve pain, lose weight, and build muscles.

The processing unit 290B inputs a prompt including an instruction for inquiring about a list of titles associated with the task corresponding to the generated search intention corresponding to the second prompt to the data generation model 580 as the third prompt, and generates a list of titles corresponding to the third prompt. The task corresponding to the search intention is, for example, a task that can solve the purpose of the viewing user, such as “relieving fatigue” in a case in which the search intention is “wanting to relieve fatigue”.

The output unit 290C outputs the result of the specific processing to the smart device 14. Specifically, the output unit 290C outputs a list of titles corresponding to the third prompt generated by the processing unit 290B to the smart device 14. As a result, the list of titles is displayed on the display 40A of the smart device 14. In a case in which the acquisition unit 290A acquires the input data (hereinafter, “interest information”) indicating the interest of the viewing user with respect to a predetermined title in the list of titles, the output unit 290C outputs a created sentence associated with the predetermined title to the smart device 14. As a result, the created sentence is displayed on the display 40A of the smart device 14. The interest information is input data in which a predetermined title and predefined words/phrases indicating an interest such as “I want to know more” and “Tell me more” are input. The list of titles is an example of a “list of key points” according to the technology of the disclosure, and the predetermined title is an example of the “predetermined key point” according to the technology of the disclosure.

The assignment unit 290D assigns a reward to the posting user who has created the created sentence associated with the title output to the smart device 14 and the posting user who has created the created sentence output to the smart device 14. Specifically, the assignment unit 290D assigns a financial reward according to the number of views to the posting user. Timing and method of assigning the reward are not particularly limited, but for example, the assignment unit 290D deposits an amount of money corresponding to the number of views to a bank account of the posting user at a predetermined cycle.

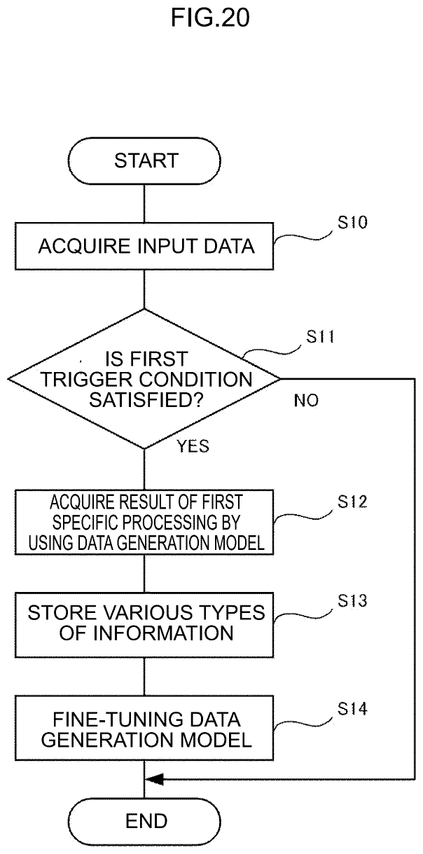

FIG. 20 schematically illustrates an example of an operation flow related to an operation in which the specific processing unit 290 performs the first specific processing of generating a task that can be solved by the content of a created sentence and a title of the created sentence. The operation flow illustrated in FIG. 20 is performed by the specific processing unit 290 reading the specific processing program 560 from the storage 32, loading the specific processing program onto the RAM 30, and executing the specific processing program. The operation flow illustrated in FIG. 20 is repeatedly and automatically executed, for example, every lapse of a certain period of time.

In step S10 illustrated in FIG. 20, the specific processing unit 290 acquires input data indicating a user input received by the smart device 14. The specific processing unit 290 proceeds to step S11.

In step S11, the specific processing unit 290 determines whether or not the input data acquired in step S10 satisfies a first trigger condition. Here, in a case in which it is determined that the first trigger condition is satisfied (step S11: YES), the specific processing unit 290 proceeds to step S12. On the other hand, in a case in which it is determined that the first trigger condition is not satisfied (step S11: NO), the specific processing unit 290 ends the operation flow illustrated in FIG. 20. As an example, the specific processing unit 290 determines that the first trigger condition is satisfied in a case in which the input data acquired in step S10 is the created sentence.

In step S12, the specific processing unit 290 inputs a prompt including the created sentence acquired in step S10, a task that can be solved by the content of the created sentence, and an instruction for generating a title of the created sentence to the data generation model 580 as the first prompt, and acquires a result of the first specific processing on the basis of an output of the data generation model 580. For example, it is assumed that the specific processing unit 290 acquires text data such as “How to relieve physical fatigue will be explained. First, . . . (omitted)”. In this case, the specific processing unit 290 inputs text such as “Please generate a task that can be solved by the content of the following sentence and a title of the sentence. Sentence: How to relieve physical fatigue will be explained. First, . . . (omitted)” to the data generation model 580 as the first prompt. Here, the specific processing unit 290 acquires a task and a title corresponding to the first prompt as a result of the first specific processing. The specific processing unit 290 proceeds to step S13.

In step S13, the specific processing unit 290 stores various types of information. Specifically, the specific processing unit 290 stores the task and the title corresponding to the first prompt acquired in step S12, the created sentence acquired in step S10, and the posting user who has created the created sentence in the database 24 in association with each other. The specific processing unit 290 proceeds to step S14.

In step S14, the specific processing unit 290 fine-tunes the data generation model 580 by using the pair of the task and the title corresponding to the first prompt acquired in step S12 as learning data. The specific processing unit 290 ends the operation flow illustrated in FIG. 20.

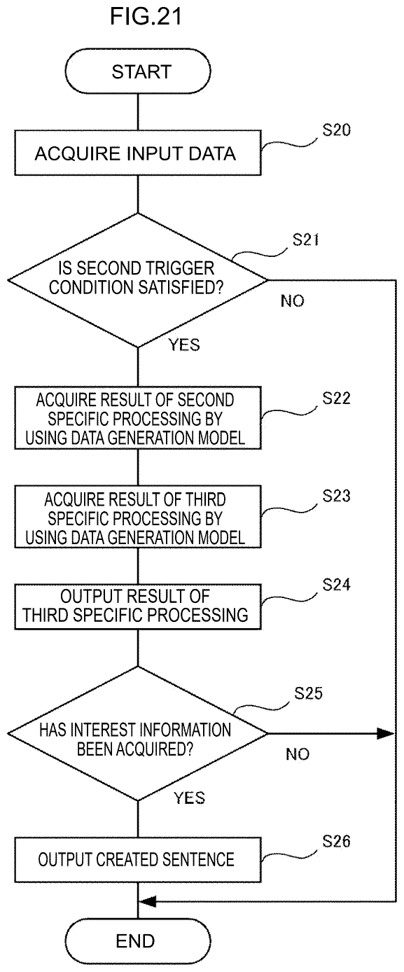

FIG. 21 schematically illustrates an example of an operation flow related to an operation in which the specific processing unit 290 performs second specific processing of generating a search intention of a viewing user and third specific processing of generating a list of titles associated with a task corresponding to the search intention. The operation flow illustrated in FIG. 21 is performed by the specific processing unit 290 reading the specific processing program 560 from the storage 32, developing the specific processing program in the RAM30, and executing the specific processing program. The operation flow illustrated in FIG. 21 is repeatedly and automatically executed, for example, every lapse of a certain period of time.

In step S20 illustrated in FIG. 21, the specific processing unit 290 acquires input data indicating a user input received by the smart device 14. The specific processing unit 290 proceeds to step S21.

In step S21, the specific processing unit 290 determines whether or not the input data acquired in step S20 satisfies a second trigger condition. Here, in a case in which it is determined that the second trigger condition is satisfied (step S21: YES), the specific processing unit 290 proceeds to step S22. On the other hand, in a case in which it is determined that the second trigger condition is not satisfied (step S21: NO), the specific processing unit 290 ends the operation flow illustrated in FIG. 21. As an example, in a case in which the input data acquired in step S20 is a search query, the specific processing unit 290 determines that the second trigger condition is satisfied.

In step S22, the specific processing unit 290 inputs a prompt including the search query acquired in step S20 and an instruction for inquiring about a search intention of the viewing user assumed from the search query to the data generation model 580 as the second prompt, and acquires a result of the second specific processing on the basis of an output of the data generation model 580. For example, it is assumed that the specific processing unit 290 acquires text data such as “Recently, I have had trouble relieving fatigue.” as a search query. In this case, the specific processing unit 290 inputs text such as “Please extract an assumed search intention of the viewing user from the following search query. Search query: Recently, I have had trouble relieving fatigue.” to the data generation model 580 as the second prompt. Here, the specific processing unit 290 acquires the search intention corresponding to the second prompt as a result of the second specific processing. The specific processing unit 290 proceeds to step S23.

In step S23, the specific processing unit 290 inputs a prompt including an instruction for inquiring about a list of titles associated with a task corresponding to the search intention corresponding to the second prompt acquired in step S22 to the data generation model 580 as the third prompt, and acquires a result of the third specific processing on the basis of an output of the data generation model 580. For example, it is assumed that the specific processing unit 290 acquires text data such as “I want to relieve fatigue” as the search intention corresponding to the second prompt in step S22. In this case, the specific processing unit 290 inputs text such as “Please extract a list of titles associated with the task corresponding to the following search intention. Search intention: I want to relieve fatigue” to the data generation model 580 as the third prompt. Here, the specific processing unit 290 acquires a list of titles corresponding to the third prompt as a result of the third specific processing. The specific processing unit 290 proceeds to step S24.

In step S24, the specific processing unit 290 outputs the result of the third specific processing to the smart device 14 of the viewing user. Specifically, the specific processing unit 290 outputs the list of titles corresponding to the third prompt acquired in step S23 to the smart device 14 of the viewing user. As a result, the list of the titles is displayed on the display 40A of the smart device 14. The specific processing unit 290 proceeds to step S25.

In step S25, the specific processing unit 290 determines whether or not interest information has been acquired. Here, in a case in which it is determined that the interest information is acquired (step S25: YES), the specific processing unit 290 proceeds to step S26. On the other hand, in a case in which it is determined that the interest information is not acquired (step S25: NO), the specific processing unit 290 ends the operation flow illustrated in FIG. 21.

In step S26, the specific processing unit 290 acquires the created sentence associated with the predetermined title from the database 24 and outputs the created sentence to the smart device 14 of the viewing user. As a result, the created sentence is displayed on the display 40A of the smart device 14. The specific processing unit 290 ends the operation flow illustrated in FIG. 21.

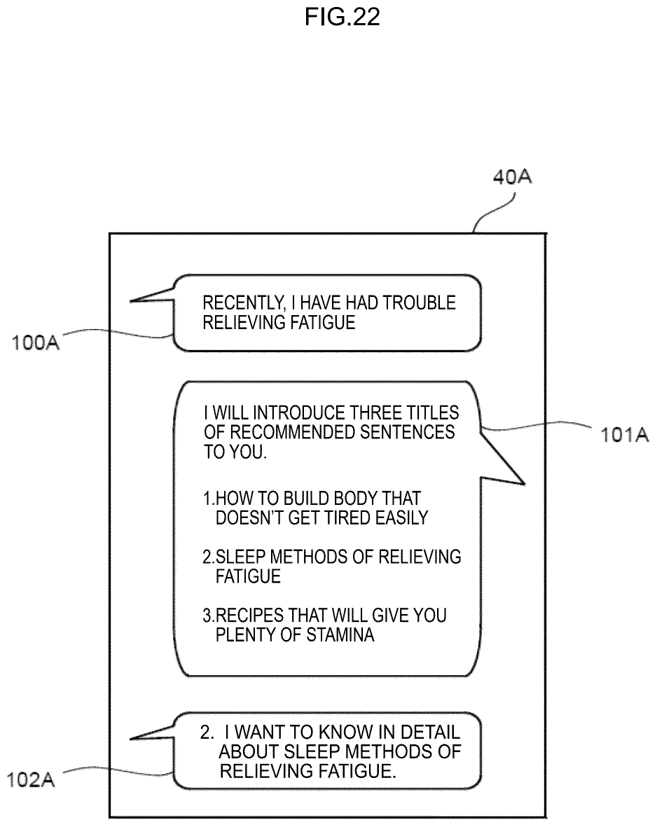

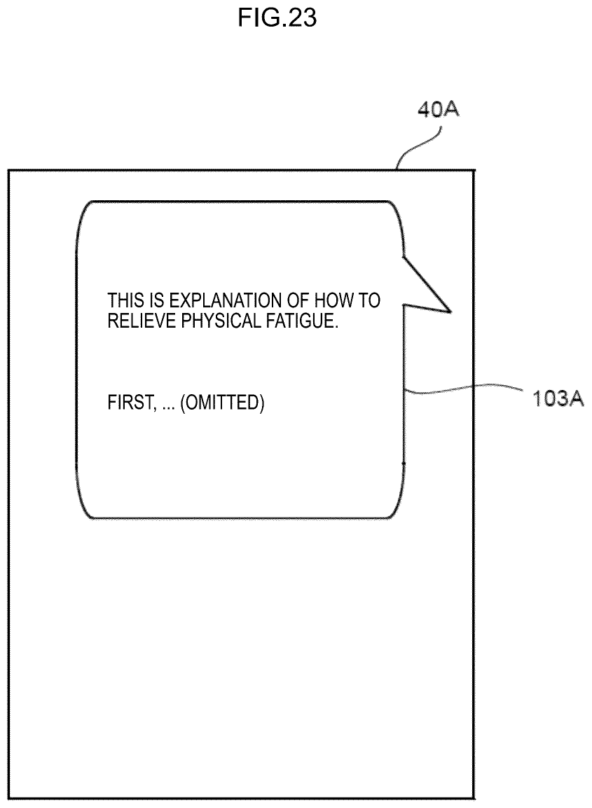

Next, a result of the specific processing displayed on the display 40A of the smart device 14 of the viewing user will be described with reference to FIGS. 22 and 23. Specifically, the display examples illustrated in FIGS. 22 and 23 illustrate a screen of the specific application being executed on the smart device 14.

As illustrated in FIG. 22, a user input 100A, an AI response 101A, and a user input 102A are displayed on the display 40A.

The user input 100A indicates a sentence “Recently, I have had trouble relieving fatigue” in which the text input by the viewing user is received. Here, the control unit 46A of the smart device 14 transmits input data indicating the user input 100A to the data processing apparatus 120.

The AI response 101A indicates text data output from the data generation model 580. Here, the specific processing unit 290 of the data processing apparatus 120 acquires the input data indicating the user input 100A transmitted from the smart device 14. Next, the specific processing unit 290 inputs a prompt including the search query acquired as the input data and an instruction for inquiring about a search intention of the viewing user assumed from the search query to the data generation model 580 as the second prompt, and acquires a result of the second specific processing on the basis of an output of the data generation model 580. Next, the specific processing unit 290 inputs a prompt including an instruction for inquiring about a list of titles associated with the task corresponding to the search intention corresponding to the second prompt acquired as a result of the second specific processing to the data generation model 580 as the third prompt, and acquires a result of the third specific processing on the basis of an output of the data generation model 580. The specific processing unit 290 outputs a list of titles corresponding to the third prompt acquired as a result of the third specific processing to the smart device 14. As a result, the list of the titles is displayed on the display 40A of the smart device 14 as the AI response 101A. Specifically, in FIG. 22, as the AI response 101A, “I will introduce three titles of sentences recommended to you. 1. How to build a body that doesn't get tired easily 2. Sleeping methods of relieving fatigue 3. Recipes that will give you plenty of stamina.” is displayed as a list of titles.

The user input 102A indicates a sentence “2. I want to know in detail about the sleeping methods of relieving fatigue” in which the text input by the viewing user is received. Here, the control unit 46A of the smart device 14 transmits input data indicating the user input 102A to the data processing apparatus 120.

As illustrated in FIG. 23, an AI response 103A is displayed on the display 40A.

The AI response 103A indicates the text data output from the data generation model 580. Here, the specific processing unit 290 of the data processing apparatus 120 acquires input data indicating the user input 102A transmitted from the smart device 14. Next, the specific processing unit 290 determines that interest information has been acquired on the basis of the input data. In this case, the specific processing unit 290 acquires, from the database 24, a created sentence associated with the “sleeping methods of relieving fatigue” that is a predetermined title, and outputs the created sentence to the smart device 14 of the viewing user. As a result, the created sentence is displayed on the display 40A of the smart device 14 as the AI response 103A. Specifically, in FIG. 23, as the AI response 103A, the created sentence such as “A method for relieving physical fatigue will be explained. First, . . . (omitted)” is displayed.

As described above, in the data processing apparatus 120, the specific processing unit 290 inputs a prompt including the acquired created sentence, a task that can be solved by the content of the created sentence, and an instruction for generating a title of the created sentence to the data generation model 580 as the first prompt, and generates the task and the title corresponding to the first prompt. The specific processing unit 290 stores the generated task and title corresponding to the first prompt, the created sentence, and the posting user who has created the created sentence in the database 24 in association with each other. The specific processing unit 290 inputs a prompt including the acquired search query and an instruction for inquiring about a search intention of the viewing user assumed from the search query to the data generation model 580 as the second prompt, and generates the search intention corresponding to the second prompt. The specific processing unit 290 inputs a prompt including an instruction for inquiring about a list of titles associated with the task corresponding to the generated search intention corresponding to the second prompt to the data generation model 580 as the third prompt, and generates a list of titles corresponding to the third prompt. The specific processing unit 290 outputs the list of titles corresponding to the third prompt to the smart device 14, and outputs the created sentence associated with the predetermined title to the smart device 14 in a case in which the interest information has been acquired.

With the above configuration, the data processing apparatus 120 can output the list of titles associated with the task corresponding to the search intention of the viewing user to the smart device 14. The data processing apparatus 120 can output, to the smart device 14, the created sentence in which the viewing user has indicated an interest from the list of the titles. As a result, according to the data processing apparatus 120, it is possible to appropriately respond to the user input and output the list of titles and the created sentence suitable for the viewing user to the smart device 14 of the viewing user.

In the data processing apparatus 120, the specific processing unit 290 assigns a reward to the posting user who has created the created sentence associated with the title output to the smart device 14 of the viewing user and the posting user who has created the created sentence output to the smart device 14. As a result, according to the data processing apparatus 120, it is possible to increase the desire of the posting user to create the created sentence.

In the data processing apparatus 120, the specific processing unit 290 fine-tunes the data generation model 580 by using a generated pair of a task and a title corresponding to the first prompt as learning data. As a result, according to the data processing apparatus 120, it is possible to generate a task and a title corresponding to the first prompt with high accuracy compared with a case in which fine tuning is not performed.

### Sixth Embodiment

Next, a sixth embodiment of the data processing system 1000 according to the embodiment will be described while omitting or simplifying a portion overlapping with the above embodiments.

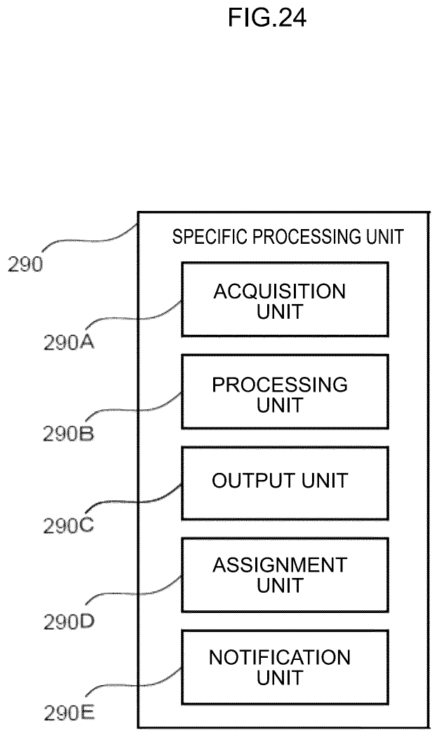

FIG. 24 is a second block diagram illustrating an example of a functional configuration of the specific processing unit 290. As illustrated in FIG. 24, the specific processing unit 290 includes an acquisition unit 290A, a processing unit 290B, an output unit 290C, an assignment unit 290D, and a notification unit 290E.

In a case in which the similarity between a plurality of created sentences stored in the database 24 is a predetermined value or more and posting users who have created the plurality of created sentences are different from each other, the notification unit 290E notifies an original user, who is the posting user who has created the created sentence first acquired by the acquisition unit 290A among the plurality of created sentences, of the presence of a similar created sentence.

The notification unit 290E periodically acquires a plurality of created sentences stored in the database 24 and extracts a plurality of created sentences having a similarity of a predetermined value or more. As an example, the notification unit 290E determines how a plurality of created sentences are similar to each other by using a cosine similarity as the similarity. In a case in which posting users who have created the plurality of created sentences each having the cosine similarity of a predetermined value or more are different from each other, the notification unit 290E notifies the smart device 14 of the original user of presence of the similar created sentence.

The acquisition unit 290A acquires a deletion instruction from the original user as input data. For example, the original user transmits text data “Please delete similar created sentences” to the data processing apparatus 120 as a deletion instruction via the smart device 14.

In a case in which the acquisition unit 290A acquires the deletion instruction from the original user, the processing unit 290B deletes the created sentence created by another posting user similar to the created sentence created by the original user from the database 24.

With the above configuration, in the data processing apparatus 120, it is possible to prevent the created sentence created by another posting user assumed to mimic the created sentence created by the original user from being output to the smart device 14 of the viewing user.

### Seventh Embodiment

Next, a seventh embodiment of the data processing system 1000 according to the embodiment will be described while omitting or simplifying a portion overlapping with the above embodiment.

A functional configuration of the specific processing unit 290 according to the seventh embodiment is, for example, the functional configuration illustrated in FIG. 24 similar to that of the sixth embodiment.

The acquisition unit 290A acquires a viewing history of a created sentence by a viewing user as input data. The acquisition unit 290A stores the acquired viewing history in the database 24 in association with the viewing user.

The processing unit 290B inputs a prompt including a search query acquired as input data by the acquisition unit 290A, a viewing history of a created sentence by a viewing user who has input the input data stored in the database 24, and an instruction for inquiring about a search intention of the viewing user assumed from the search query to the data generation model 580 as the second prompt, and generates the search intention corresponding to the second prompt.

With the above configuration, the data processing apparatus 120 can generate the search intention based on the viewing history of the created sentence by the viewing user. As a result, according to the data processing apparatus 120, it is possible to generate the search intention of the viewing user with high accuracy compared with a case in which the viewing history of the created sentence by the viewing user is not input to the data generation model 580.

### Eighth Embodiment

Next, an eighth embodiment of the data processing system 1000 according to the embodiment will be described while omitting or simplifying a portion overlapping with the above embodiment.

A functional configuration of the specific processing unit 290 according to the eighth embodiment is, for example, the functional configuration illustrated in FIG. 24 similar to that of the sixth embodiment.

The acquisition unit 290A acquires user information indicating an attribute of a viewing user as input data. The user information is information such as an age, a gender, a hobby, a special skill, and occupation of the viewing user input in advance by the viewing user.

In a case in which an inappropriate title not suitable for the attribute of the viewing user indicated by the user information is included in the list of titles corresponding to the third prompt generated by the processing unit 290B, the output unit 290C outputs a list of titles excluding the inappropriate title to the smart device 14 of the viewing user. The inappropriate title is a title including a term assumed to be inappropriate for each attribute (for example, an age or a gender) of the viewing user. The term that is an inappropriate title for each attribute of the viewing user is manually set in the data processing apparatus 120 in advance, for example. The inappropriate title is an example of “inappropriate key point” according to the technology of the disclosure.

For example, in a case in which there are a list of five titles corresponding to the third prompt, and there are two inappropriate titles that are not suitable for the attribute of the viewing user indicated by the user information in the five titles, the output unit 290C outputs a list of three titles excluding the two inappropriate titles to the smart device 14 of the viewing user.

With the above configuration, the data processing apparatus 120 can filter the created sentences viewable by the viewing user according to the attribute of the viewing user.

### (Others)

In the above embodiment, the key point of the created sentence has been described as a “title of the created sentence”, but as described above, the key point of the created sentence may include at least one of the title or the summary of the created sentence. Therefore, in the above embodiment, the key point of the created sentence may be referred to as “summary of the created sentence”, and the key point of the created sentence may be referred to as “title and summary of the created sentence”.

In a case in which the key point of the created sentence is “title and summary of the created sentence”, the specific processing unit 290 performs the specific processing as follows. In this case, the specific processing unit 290 inputs a prompt including an acquired created sentence, a task that can be solved by the content of the created sentence, and an instruction for generating a title and a summary of the created sentence to the data generation model 580 as the first prompt, and generates the task, the title, and the summary corresponding to the first prompt. The specific processing unit 290 stores the generated task, title, and summary corresponding to the first prompt, the created sentence that is the basis of the task, the title, and the summary, and the posting user who has created the created sentence in the database 24 in association with each other. The specific processing unit 290 fine-tunes the data generation model 580 by using a pair of the generated task and title corresponding to the first prompt and a pair of the generated task and summary corresponding to the first prompt as learning data. The specific processing unit 290 inputs a prompt including an instruction for inquiring about a list of titles or summaries associated with the task corresponding to the generated search intention corresponding to the second prompt to the data generation model 580 as the third prompt, and generates a list of titles or summaries corresponding to the third prompt. The specific processing unit 290 outputs a list of generated titles or summaries corresponding to the third prompt to the smart device 14.

The emotion specifying model 61 may determine an emotion of the user in accordance with a specific mapping. Specifically, the emotion specifying model 61 may determine the emotion of the user in accordance with the emotion map 400 (see FIG. 5) that is a specific mapping.

Here, a human emotion is based on various balances such as a posture and a blood glucose level, and indicates a state of displeasure in a case in which the balances go away from the ideal and a state of pleasure in a case in which the balances approach the ideal. Even in a robot, an automobile, a motorcycle, or the like, on the basis of various balances such as a posture and a remaining battery level, it is possible to create an emotion to indicate a state of displeasure in a case in which the balances go away from the ideal and a state of pleasure in a case in which the balances approach the ideal. The emotion map may be generated on the basis of, for example, an emotion map of Dr. Mitsuyoshi (Research on the phonetic recognition of feelings and a system for emotional physiological brain signal analysis, Tokushima University, PhD thesis: https://ci.nii.ac.jp/naid/500000375379). In the left half of the emotion map, emotions belonging to a region called “reaction” in which sensation is dominant are arranged. In the right half of the emotion map, emotions belonging to a region called “situation” in which situation recognition is dominant are arranged.

In the emotion map, two emotions for prompting learning are defined. One is an emotion around the middle of negative “repentance” or “reflection” on the situation side. That is, this emotion is a negative emotion such as “I do not want to feel this again” or “I do not want to be reprimanded” that occurs in the robot. The other is an emotion around positive “desire” on the reaction side. That is, the emotion is a positive emotion such as “want more” or “want to know more”.

The emotion specifying model 61 inputs a user input to a neural network trained in advance, acquires an emotion value indicating each emotion indicated in the emotion map 400, and determines an emotion of the user. This neural network is trained in advance on the basis of a plurality of pieces of learning data that is a combination of the user input and the emotion value indicating each emotion illustrated in the emotion map 400. This neural network is trained such that, as in the emotion map 900 illustrated in FIG. 6, emotions disposed close to each other have close values. FIG. 6 illustrates an example in which a plurality of emotions such as “safe”, “calm”, and “reassuring” have close emotion values.

In the above embodiment, the form example in which the specific processing is performed by one computer 22 has been described, but the technology of the disclosure is not limited thereto, and the distributed processing for the specific processing of a plurality of computers including the computer 22 may be performed.

In the above embodiment, the form example in which the specific processing program 560 is stored in the storage 32 has been described, but the technology of the disclosure is not limited thereto. For example, the specific processing program 560 may be stored in a portable computer-readable non-transitory storage medium such as a universal serial bus (USB) memory. The specific processing program 560 stored in the non-transitory storage medium is installed in the computer 22 of the data processing apparatus 120. The processor 28 executes the specific processing according to the specific processing program 560.

The specific processing program 560 may be stored in a storage device such as a server connected to the data processing apparatus 120 via the network 540, and the specific processing program 560 may be downloaded and installed in the computer 22 in response to a request from the data processing apparatus 120.

It is not necessary to store the whole of the specific processing program 560 in a storage device such as a server connected to the data processing apparatus 120 via the network 540 or to store the whole of the specific processing program 560 in the storage 32, and a part of the specific processing program 560 may be stored.

The following various processors can be used as hardware resources for executing the specific processing. Examples of the processor include software, that is, a CPU which is a general-purpose processor functioning as a hardware resource that executes the specific processing by executing a program. Examples of the processor include a dedicated electric circuit which is a processor having a circuit configuration exclusively designed for executing the specific processing, such as a field-programmable gate array (FPGA), a programmable logic device (PLD), or an application specific integrated circuit (ASIC). A memory is built in or connected to any processor, and any processor executes the specific processing by using the memory.

The hardware resource that executes the specific processing may be configured by one of these various processors, or may be configured by a combination (for example, a combination of a plurality of FPGAs or a combination of a CPU and an FPGA) of two or more processors of the same or different types. The hardware resource that executes the specific processing may be one processor.

As an example of the configuration including one processor, first, there is a form in which one processor is configured by a combination of one or more CPUs and software, and the processor functions as a hardware resource that executes the specific processing. Second, as typified by a system-on-a-chip (SoC) or the like, there is a form of using a processor that realizes a function of the entire system including a plurality of hardware resources for executing the specific processing with one IC chip. As described above, the specific processing is realized by using one or more of the above-described various processors as hardware resources.

More specifically, an electric circuit in which circuit elements such as semiconductor elements are combined can be used as a hardware structure of these various processors. The above specific processing is merely an example. Therefore, it is needless to say that unnecessary steps may be deleted, new steps may be added, or the processing order may be changed within the scope not departing from the key point.

The contents described and illustrated above are detailed descriptions of parts according to the technology of the disclosure, and are merely examples of the technology of the disclosure. For example, the above description regarding the configuration, function, operation, and effect is a description regarding an example of the configuration, function, operation, and effect of the portion according to the technology of the disclosure. Therefore, it is needless to say that unnecessary portions may be deleted, new elements may be added, or replacement may be made with respect to the above described and illustrated contents without departing from the key point of the technology of the disclosure. In order to avoid complication and to facilitate understanding of the portion according to the technology of the disclosure, in the description content and the illustrated content described above, description regarding technical common sense or the like that does not require any particular description in enabling implementation of the technology of the disclosure is omitted.

All documents, patent applications, and technical standards described in this specification are incorporated herein by reference to the same extent as if each document, patent application, and technical standard were specifically and individually indicated to be incorporated by reference.

### Ninth Embodiment

Next, a ninth embodiment of the data processing system 1000 according to the embodiment will be described.

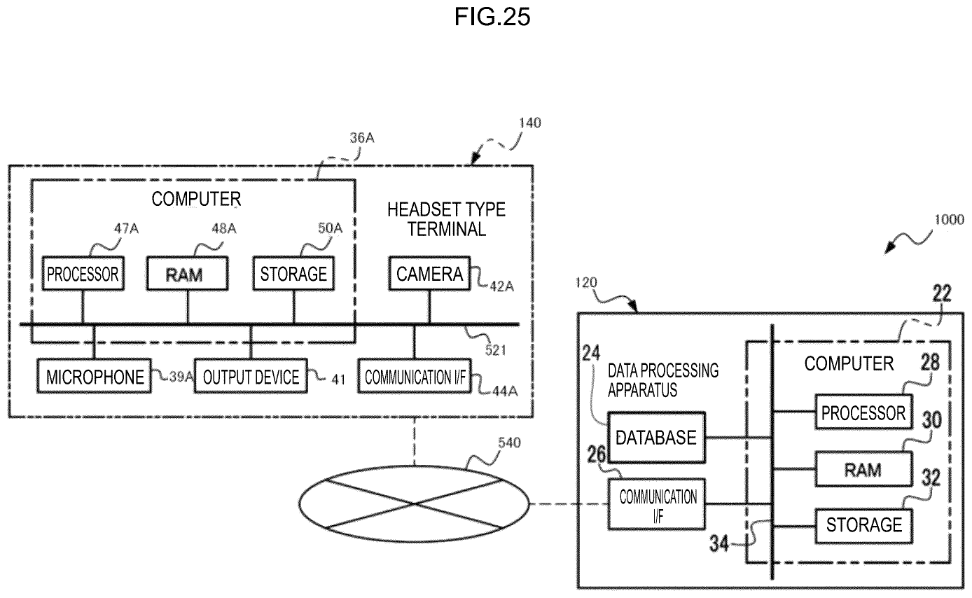

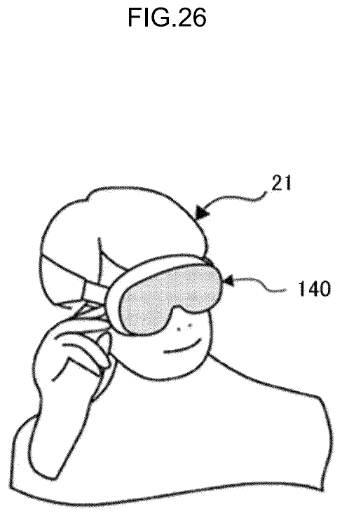

FIG. 25 illustrates an example of a configuration of the data processing system 1000 according to the embodiment.

As illustrated in FIG. 25, the data processing system 1000 includes a data processing apparatus 120 and a headset type terminal 140. An example of the data processing apparatus 120 is a server. In the present embodiment, the data processing apparatus 120 is an example of a “data processing apparatus” according to the technology of the disclosure, and the headset type terminal 140 is an example of an “electronic apparatus” according to the technology of the disclosure.

The data processing apparatus 120 includes a computer 22, a database 24, and a communication I/F 26. The computer 22 is an example of a “computer” according to the technology of the disclosure. The computer 22 includes a processor 28, a RAM 30, and a storage 32. The processor 28, the RAM 30, and the storage 32 are connected to a bus 34. The database 24 and the communication I/F 26 are also connected to the bus 34. The communication I/F 26 is connected to a network 540. Examples of the network 540 include a wide area network (WAN) and/or a local area network (LAN).

The headset type terminal 140 includes a computer 36A, a microphone 39A, an output device 41, a camera 42A, and a communication I/F 44A. The computer 36A includes a processor 47A, a RAM 48A, and a storage 50A. The processor 47A, the RAM 48A, and the storage 50A are connected to a bus 521. The microphone 39A, the output device 41, and the camera 42A are also connected to the bus 521.

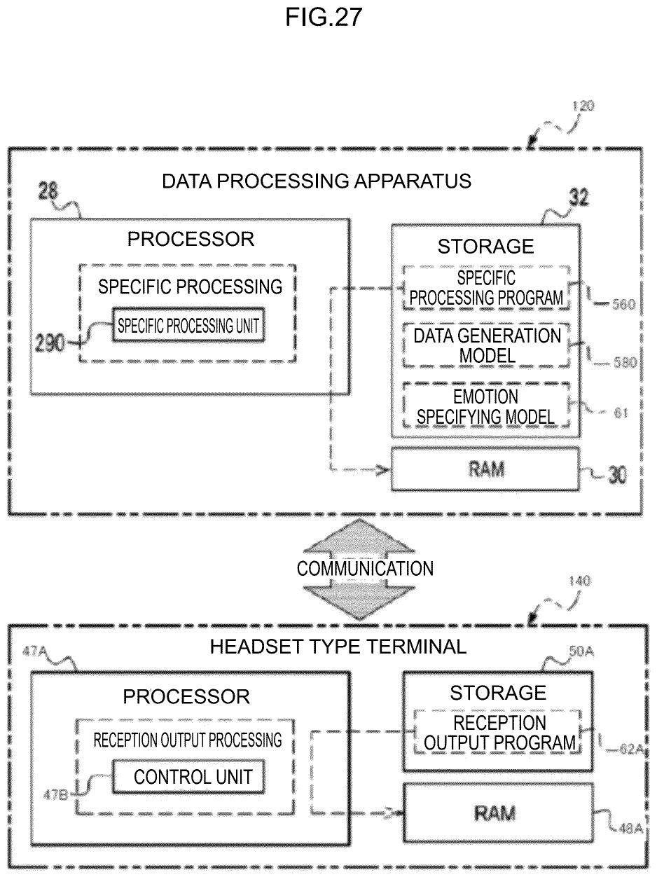

The microphone 39A receives an instruction or the like from a user 21 by receiving vocal sound output by the user 21 (see FIG. 26). The microphone 39A captures vocal sound output by the user 21, converts the captured vocal sound into vocal sound data, and outputs the vocal sound data to the processor 47A. The control unit 47B (see FIG. 27) of the processor 47A transmits input data indicating the user input received by the microphone 39A to the data processing apparatus 120. In the data processing apparatus 120, the specific processing unit 290 acquires input data indicating a user input.

The output device 41 includes a display, a speaker, and the like which are not illustrated, and presents data to the user 21 by outputting the data in an expression form (for example, vocal sound and/or text) perceivable by the user 21. The display displays visible information such as text and images in response to an instruction from the processor 47A. The speaker outputs vocal sound in response to an instruction from the processor 47A.

The camera 42A is a small digital camera equipped with an optical system such as a lens, a diaphragm, and a shutter, and an imaging element such as a complementary metal-oxide-semiconductor (CMOS) image sensor or a charge coupled device (CCD) image sensor, and captures an image around the user 21 (for example, an imaging range defined by an angle of view corresponding to a width of a field of view of a general healthy person).

The communication I/F 44A is connected to the network 540. The communication I/Fs 44A and 26 manage exchange of various types of information between the processor 47A and the processor 28 via the network 540. Various types of information are exchanged between the processor 47A and the processor 28 using the communication I/Fs 44A and 26 in a secure state.

FIG. 26 is an explanatory diagram illustrating an example of the headset type terminal 140. As illustrated in FIG. 26, the headset type terminal 140 is a goggle-type smart device, and is worn to cover the eyes of the user 21 similarly to general goggles.

FIG. 27 illustrates an example of main part functions of the data processing apparatus 120 and the headset type terminal 140. As illustrated in FIG. 27, in the data processing apparatus 120, specific processing is performed by the processor 28. The storage 32 stores a specific processing program 560.

The specific processing program 560 is an example of a “data processing program” according to the technology of the disclosure. The processor 28 reads the specific processing program 560 from the storage 32 and executes the read specific processing program 560 on the RAM 30. The specific processing is realized by the processor 28 operating as the specific processing unit 290 according to the specific processing program 560 executed on the RAM 30.

The storage 32 stores a data generation model 580 and an emotion specifying model 61. The data generation model 580 and the emotion specifying model 61 are used by the specific processing unit 290.

In the headset type terminal 140, the processor 47A performs reception output processing. The storage 50A stores a reception output program 62A. The processor 47A reads the reception output program 62A from the storage 50A, and executes the read reception output program 62A on the RAM 48A. The reception output process is realized by the processor 47A operating as the control unit 47B according to the reception output program 62A executed on the RAM 48A.

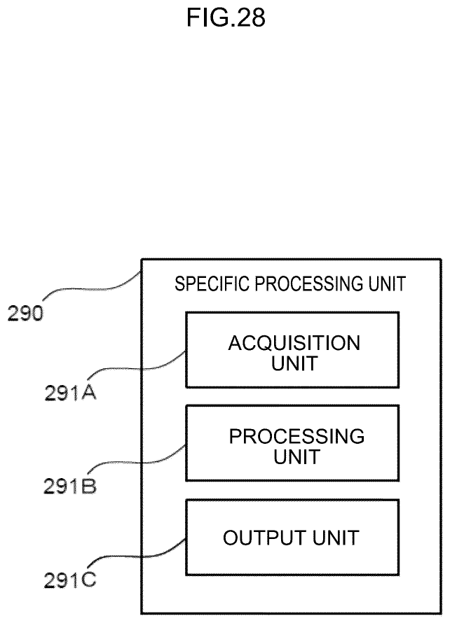

Next, processing of the specific processing unit 290 in a case in which the data processing apparatus 120 performs specific processing of generating information according to input data indicating a user input will be described. FIG. 28 is a block diagram illustrating an example of a functional configuration of the specific processing unit 290.

As illustrated in FIG. 28, the specific processing unit 290 includes an acquisition unit 291A, a processing unit 291B, and an output unit 291C.

The acquisition unit 291A acquires input data indicating a user input received by the headset type terminal 140. Specifically, the acquisition unit 291A acquires input data based on vocal sound input of the user 21 received by the headset type terminal 140.

The acquisition unit 291A acquires destination information designating a destination and time point information designating a time point as input data. For example, the acquisition unit 291A acquires destination information and time point information as input data based on vocal sound input of the user 21 received by the headset type terminal 140. Here, the destination information is input data indicating a destination (examples: Tokyo, Hokkaido, and Okinawa) existing in the real world or a destination existing in virtual worlds such as a game and an animation. The time point information is input data indicating a past, present, or future time point. The time point that can be designated in the time point information is not particularly limited, and may be in units of years, months, or days, or may include hours and minutes.

The processing unit 291B performs specific processing using the data generation model 580. The data generation model 580 is so-called generative artificial intelligence (AI). The data generation model 580 is configured by combining generative AI such as ChatGPT, Stable Diffusion, and Gen-2, for example. Since ChatGPT is known as disclosed in, for example, Internet search <URL: https://openai.com/blog/chatgpt> and Internet search <URL: https://aismiley.co.jp/ai_news/chatgpt-tsukattemita/>, a detailed description thereof will be omitted. Since Stable Diffusion is known as disclosed in, for example, Internet search <URL: https://ja.stability.ai/stable-diffusion> and Internet search <URL: https://aismiley.co.jp/ai_news/what-is-stable-diffusion/>, a detailed description thereof will be omitted. Since Gen-2 is known as disclosed in, for example, Internet search <URL: https://research.runwayml.com/gen2> and Internet search <URL: https://find-a.jp/seotimes/runway/>, a detailed description thereof will be omitted.

The data generation model 580 is obtained by causing the neural network to perform deep learning. To the data generation model 580, a prompt including an instruction is input, and inference data such as vocal sound data indicating vocal sound, text data indicating text, and image data indicating an image is input. The data generation model 580 infers the input inference data according to the instruction indicated by the prompt, and outputs an inference result in data formats such as vocal sound data, text data, image data, and moving image data. Here, the inference indicates, for example, analysis, classification, prediction, and/or summary. The data generation model 580 is an example of a “generation model” according to the technology of the disclosure.

The above-described specific processing includes first specific processing of acquiring an image of a destination designated by the user 21 as information according to input data, and second specific processing of generating a moving image of the destination at a time point designated by the user 21 as the information.

The processing unit 291B inputs a prompt including the destination information and the time point information acquired by the acquisition unit 291A and an instruction for inquiring about the image of the destination at the time point indicated by the destination information and the time point information to the data generation model 580 as the first prompt, and acquires the image of the destination corresponding to the first prompt. In this case, the processing unit 291B may acquire an image searched from the Internet by the data generation model 580 as an “image of a destination”, or may acquire an image generated by the data generation model 580 as an “image of a destination”.

The processing unit 291B inputs a prompt including destination information, time point information, an image of a destination corresponding to the first prompt, and an instruction for generating a moving image of the destination at a time point indicated by the destination information and the time point information to the data generation model 580 as the second prompt, and generates a moving image of the destination corresponding to the second prompt.

The output unit 291C outputs the result of the specific processing to the headset type terminal 140. Specifically, the output unit 291C outputs the moving image of the destination corresponding to the second prompt generated by the processing unit 291B to the headset type terminal 140. In the headset type terminal 140, the control unit 47B causes the output device 41 to output the result of the specific processing. As a result, the output device 41 of the headset type terminal 140 reproduces the moving image of the destination.

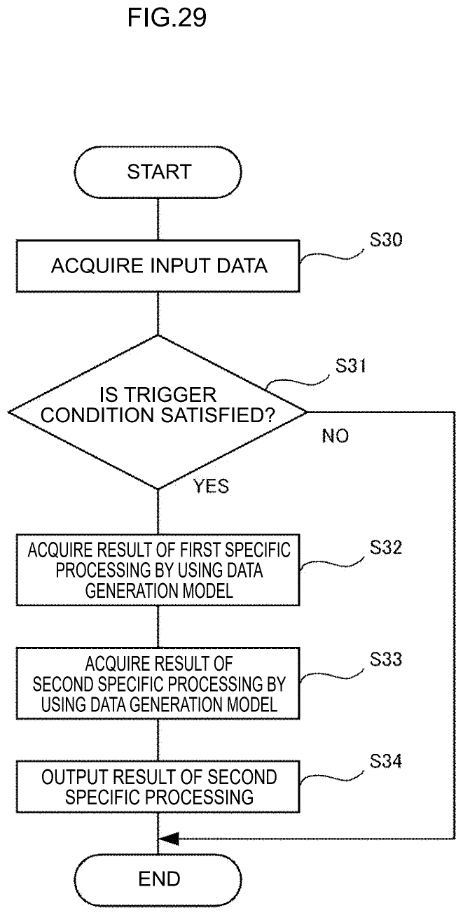

FIG. 29 schematically illustrates an example of an operation flow related to an operation in which the specific processing unit 290 performs the first specific processing of acquiring an image of a destination designated by the user 21 and the second specific processing of generating a moving image of the destination at a time point designated by the user 21. The operation flow illustrated in FIG. 29 is performed by the specific processing unit 290 reading the specific processing program 560 from the storage 32, loading the specific processing program onto the RAM 30, and executing the specific processing program. The operation flow illustrated in FIG. 29 is repeatedly and automatically executed, for example, every lapse of a certain period of time.

In step S30 illustrated in FIG. 29, the specific processing unit 290 acquires input data indicating a user input received by headset type terminal 140. The specific processing unit 290 proceeds to step S31.

In step S31, the specific processing unit 290 determines whether or not the input data acquired in step S30 satisfies a trigger condition. Here, in a case in which it is determined that the trigger condition is satisfied (step S31: YES), the specific processing unit 290 proceeds to step S32. On the other hand, in a case in which it is determined that the trigger condition is not satisfied (step S31: NO), the specific processing unit 290 ends the operation flow illustrated in FIG. 29. As an example, in a case in which the input data acquired in step S30 is the destination information and the time point information, the specific processing unit 290 determines that the trigger condition is satisfied.

In step S32, the specific processing unit 290 inputs a prompt including the destination information and the time point information acquired in step S30 and an instruction for inquiring about an image of the destination at a time point indicated by the destination information and the time point information to the data generation model 580 as the first prompt, and acquires a result of the first specific processing on the basis of an output of the data generation model 580. For example, it is assumed that the specific processing unit 290 has acquired vocal sound data of “Okinawa” as the destination information, and has acquired vocal sound data of “August, 2020” as the time point information. In this case, the specific processing unit 290 inputs text such as “Please search for or generate an image of a destination at a time point indicated by the following destination information and time point information. Destination information: Okinawa, time point information: August 2020” to the data generation model 580 as the first prompt. Here, the specific processing unit 290 acquires an image of the destination corresponding to the first prompt as a result of the first specific processing. The specific processing unit 290 proceeds to step S33.

In step S33, the specific processing unit 290 inputs a prompt including the destination information time point information acquired in step S30, the image of the destination corresponding to the first prompt acquired in step S32, and an instruction for generating a moving image of the destination at a time point indicated by the destination information and the time point information to the data generation model 580 as the second prompt, and acquires a result of the second specific processing on the basis of an output of the data generation model 580. For example, it is assumed that the specific processing unit 290 acquires image data of “xxxyyyzzz.jpg” as the image of the destination corresponding to the first prompt in step S32. In this case, the specific processing unit 290 inputs text such as “Please generate a moving image of a destination at a time point indicated by the following destination information and time point information on the basis of an image indicated by the following image data. Image data: xxxyyyzzz.jpg, destination information: Okinawa, time point information: August 2020” to the data generation model 580 as the second prompt. Here, the specific processing unit 290 acquires a moving image of the destination corresponding to the second prompt as a result of the second specific processing. The specific processing unit 290 proceeds to step S34.

In step S34, the specific processing unit 290 outputs the result of the second specific processing to the headset type terminal 140. Specifically, the specific processing unit 290 outputs the moving image of the destination corresponding to the second prompt acquired in step S33 to the headset type terminal 140. As a result, the output device 41 of the headset type terminal 140 reproduces the moving image of the destination. The specific processing unit 290 ends the operation flow illustrated in FIG. 29.

As described above, in the data processing apparatus 120, the specific processing unit 290 acquires destination information and time point information as input data. The specific processing unit 290 inputs a prompt including the acquired destination information and time point information and an instruction for inquiring about an image of the destination at a time point indicated by the destination information and the time point information to the data generation model 580 as the first prompt, and acquires an image of the destination corresponding to the first prompt. The specific processing unit 290 inputs a prompt including the destination information, the time point information, an image of the destination corresponding to the first prompt, and an instruction for generating a moving image of the destination at a time point indicated by the destination information and the time point information to the data generation model 580 as the second prompt, and generates a moving image of the destination corresponding to the second prompt. The specific processing unit 290 outputs the generated moving image of the destination corresponding to the second prompt to the headset type terminal 140.

With the above configuration, according to the data processing apparatus 120, the moving image of the destination at the time point designated by the user 21 can be output to the headset type terminal 140 in an appropriate response to the user input. As a result, the user 21 can view the moving image corresponding to the past, present, or future time point desired by the user regarding the destination desired by the user. Therefore, the user 21 can experience, for example, a pseudo trip regarding a past or future destination through the headset type terminal 140.

### Tenth Embodiment

Next, a tenth embodiment of the data processing system 1000 according to the embodiment will be described while omitting or simplifying a portion overlapping with the above embodiment.

A functional configuration of the specific processing unit 290 according to the tenth embodiment is, as an example, the functional configuration illustrated in FIG. 28 similar to that of the ninth embodiment.

The acquisition unit 291A acquires a theme of a moving image as input data. For example, the acquisition unit 291A acquires a theme of a moving image as input data based on vocal sound input of the user 21 received by the headset type terminal 140. The theme of the moving image is, for example, a slide show, motion graphics, an animation, an introduction moving image, an employment moving image, an employee meeting, a promotion, a branding moving image, or a web commercial message (CM).

The processing unit 291B inputs a prompt including the theme of the moving image acquired by acquisition unit 291A, destination information, time point information, and an image of a destination corresponding to the first prompt, and an instruction for generating a moving image of a destination at a time point indicated by the destination information and the time point information to the data generation model 580 as the second prompt, and generates a moving image of a destination corresponding to the second prompt. For example, it is assumed that the acquisition unit 291A acquires vocal sound data of “Okinawa” as the destination information, acquires vocal sound data of “August, 2020” as the time point information, and acquires vocal sound data of “introduction moving image” as the theme of the moving image. It is also assumed that the processing unit 291B has acquired image data of “xxxyyyzzz.jpg” as the image of the destination corresponding to the first prompt. In this case, for example, the processing unit 291B inputs text such as “Please generate a moving image of a destination at a time point indicated by the following destination information and time point information according to the following theme on the basis of an image indicated by the following image data. Image data: xxxyyyzzz.jpg, destination information: Okinawa, time point information: August 2020, moving image theme: introduction moving image” to the data generation model 580 as the second prompt.

With the above configuration, the data processing apparatus 120 can generate a moving image of a destination based on a theme desired by the user 21. As a result, the user 21 can enjoy a moving image according to a time point desired by the user from various viewpoints regarding a destination desired by the user by specifying various themes.

### Eleventh Embodiment

Next, an eleventh embodiment of the data processing system 1000 according to the embodiment will be described while omitting or simplifying a portion overlapping with the above embodiment.

A functional configuration of the specific processing unit 290 according to the eleventh embodiment is, as an example, the functional configuration illustrated in FIG. 28 similar to that of the ninth embodiment.

The acquisition unit 291A acquires height information regarding the height of the user 21 as input data. For example, the acquisition unit 291A acquires the height information as the input data based on the vocal sound input of the user 21 received by the headset type terminal 140. The height information is not limited to the height of the user 21 himself/herself, and may be the height of another user (for example, a child of the user 21).

The processing unit 291B generates a moving image of a destination corresponding to the second prompt in accordance with the height of the eye line derived on the basis of the height information. As an example, the processing unit 291B derives a value obtained by multiplying the height indicated by the height information by 0.9 as the “eye line height”. In this case, the processing unit 291B adds the text “Please generate a moving image from the viewpoint of the user whose eye line height is 160 cm.” to the second prompt, for example.

With the above configuration, the data processing apparatus 120 can generate a moving image of a destination from a viewpoint desired by the user 21. As a result, the user 21 can enjoy, from his/her viewpoint, a moving image corresponding to a time point desired by the user with respect to a destination desired by the user. The user 21 can check a viewpoint of another user on the basis of the generated moving image, and can check, for example, whether or not there is no danger in the destination from the viewpoint of the another user.

### Twelfth Embodiment

Next, a twelfth embodiment of the data processing system 1000 according to the embodiment will be described while omitting or simplifying a portion overlapping with the above embodiment.

A functional configuration of the specific processing unit 290 according to the twelfth embodiment is, as an example, the functional configuration illustrated in FIG. 28 similar to that of the ninth embodiment.

The acquisition unit 291A acquires time point information designating a plurality of time points as input data. For example, the acquisition unit 291A acquires time point information designating a plurality of time points as input data based on vocal sound input of the user 21 received by the headset type terminal 140.

The processing unit 291B inputs a prompt including destination information, time point information, an image of a destination corresponding to the first prompt, and an instruction for generating a moving image of the destination at a time point indicated by the destination information and the time point information to the data generation model 580 as the second prompt, and generates a moving image of the destination corresponding to the second prompt in which a plurality of time points indicated by the time point information are arranged in time series. For example, it is assumed that the acquisition unit 291A acquires vocal sound data of “Okinawa” as the destination information, and acquires vocal sound data of “August, 2020”, “August, 2021”, and “August, 2022” as the time point information. It is also assumed that the processing unit 291B has acquired image data of “xxxyyyzzz111.jpg”, “xxxyyyzzz222.jpg”, and “xxxyyyzzz333.jpg” as images of the destination corresponding to the first prompt.

In the above case, for example, the processing unit 291B inputs text such as “Please generate a moving image of a destination at a plurality of time points indicated by the following destination information and time point information in time series of the following image data 1, image data 2, and image data 3. Image data 1: xxxyyyzzz111.jpg, destination information: Okinawa, time point information: August 2020, image data 2: xxxyyyzzz222.jpg, destination information: Okinawa, time point information: August 2021, image data 3: xxxyyyzzz333.jpg, destination information: Okinawa, time point information: August 2022” to the data generation model 580 as the second prompt.

With the above configuration, the data processing apparatus 120 can generate a moving image of a destination in which a plurality of time points designated by the user 21 are arranged in time series. As a result, the user 21 can check changes in the destination at a plurality of time points designated by the user on the basis of the generated moving image.

### Thirteenth Embodiment

Next, a thirteenth embodiment of the data processing system 1000 according to the embodiment will be described while omitting or simplifying a portion overlapping with the above embodiment.

A functional configuration of the specific processing unit 290 according to the thirteenth embodiment is, as an example, the functional configuration illustrated in FIG. 28 similar to that of the ninth embodiment.

The acquisition unit 291A acquires a moving speed of a camera at the time of moving and imaging as input data. For example, the acquisition unit 291A acquires the moving speed of the camera at the time of moving and imaging as input data based on vocal sound input of the user 21 received by the headset type terminal 140. The vocal sound input of the user 21 in this case may include a specific speed such as “the moving speed of the camera is 30 km/h”, or need not include a specific speed such as “the moving speed of the camera is the speed at which a person walks” or “the moving speed of the camera is the speed at which a car runs”.

The processing unit 291B generates a moving image of a destination corresponding to the second prompt reflecting the moving speed acquired by the acquisition unit 291A. In this case, the processing unit 291B adds text “Please generate a moving image in the case of imaging while moving at 30 km/h.” to the second prompt, for example.

With the above configuration, in the data processing apparatus 120, it is possible to generate a moving image of a destination in a case in which imaging is performed with camerawork desired by the user 21. As a result, the user 21 can enjoy a moving image corresponding to a time point desired by the user with respect to a destination desired by the user, the moving image being generated by various types of camerawork desired by the user.

### (Others)

In the above embodiment, the headset type terminal 140 is an example of an “electronic apparatus” according to the technology of the disclosure, but the disclosure is not limited thereto. For example, a device different from the headset type terminal 140 such as a smartphone or a tablet terminal may be an example of the “electronic apparatus” according to the technology of the disclosure.

In the above embodiment, in the specific processing, the specific processing unit 290 may input a prompt including an instruction for inquiring about a state of the destination indicated by the acquired destination information to the data generation model 580, and acquire the state of the destination corresponding to the prompt. For example, the specific processing unit 290 acquires text data such as “there are many people”, “the sea is stormy”, or “the wind is strong” as the state of the destination.

In the above case, the specific processing unit 290 may input a prompt including a state of a destination, destination information, time point information, an image of the destination corresponding to the first prompt, and an instruction for generating a moving image of the destination at a time point indicated by the destination information and the time point information to the data generation model 580 as the second prompt, and generate a moving image of the destination corresponding to the second prompt. For example, the specific processing unit 290 inputs text such as “Please generate a moving image of a destination at a time point indicated by the following destination information and time point information on the basis of an image indicated by the following image data according to a state of the following destination. Image data: xxxyyyzzz.jpg, destination information: Okinawa, time point information: August 2020, state of destination: there are many people” to the data generation model 580 as the second prompt. With this configuration, the data processing apparatus 120 can generate a moving image of the destination based on the state of the destination.

The processing unit 291B may estimate an emotion of the user 21 by using the emotion specifying model 61 and perform specific processing using the emotion of the user 21 and the data generation model 580.

The disclosure of Japanese Patent Application No. 2023-068145 filed on Apr. 18, 2023, the disclosure of Japanese Patent Application No. 2023-135426 filed on Aug. 23, 2023, the disclosure of Japanese Patent Application No. 2023-136434 filed on Aug. 24, 2023, the disclosure of Japanese Patent Application No. 2023-146374 filed on Sep. 8, 2023, the disclosure of Japanese Patent Application No. 2023-146380 filed on Sep. 8, 2023, and the disclosure of Japanese Patent Application No. 2023-150201 filed on Sep. 15, 2023 are incorporated herein by reference in their entireties.

All documents, patent applications, and technical standards described in this specification are incorporated herein by reference to the same extent as if each document, patent application, and technical standard were specifically and individually indicated to be incorporated by reference.

1-17. (canceled)

18. A data processing apparatus comprising:
an acquisition unit that acquires input data indicating a user input;
a processing unit that performs specific processing using a generation model that generates information according to the input data; and
an output unit that outputs a result of the specific processing to an electronic apparatus, wherein
the acquisition unit acquires a created sentence that is a sentence created by a first user as the input data, the processing unit
inputs a prompt including the created sentence acquired by the acquisition unit, a task that is solvable by content of the created sentence, and an instruction for generating a key point of the created sentence to the generation model as the first prompt to generate a task and a key point corresponding to the first prompt,
stores the generated task and key point corresponding to the first prompt in a storage unit in association with the created sentence,
inputs a prompt including a search query acquired as the input data by the acquisition unit, and an instruction for inquiring about a search intention of a second user assumed from the search query to the generation model as a second prompt to generate a search intention corresponding to the second prompt, and
inputs a prompt including an instruction for inquiring about a list of key points related to the task corresponding to the generated search intention corresponding to the second prompt to the generation model as a third prompt to generate a list of key points corresponding to the third prompt, and
the output unit outputs the list of key points corresponding to the third prompt generated by the processing unit to the electronic apparatus, and outputs, in a case in which the acquisition unit acquires the input data indicating an interest of the second user in a predetermined key point in the list of key points, the created sentence related to the predetermined key point to the electronic apparatus.

19. The data processing apparatus according to claim 18, wherein
the processing unit
stores the generated task and key point corresponding to the first prompt, the created sentence, and the first user in association with each other in the storage unit, and
includes an assignment unit that assigns a reward to the first user who has created the created sentence related to the key point output to the electronic apparatus and the first user who has created the created sentence output to the electronic apparatus.

20. The data processing apparatus according to claim 18, wherein the processing unit fine-tunes the generation model by using a pair of the task and the key point corresponding to the first prompt as learning data.

21. The data processing apparatus according to claim 19, further comprising a notification unit that notifies an original user, who is the first user who has created the created sentence first acquired by the acquisition unit among a plurality of created sentences, of presence of a similar created sentence in a case in which a similarity of the plurality of created sentences stored in the storage unit is a predetermined value or more and the first users who have created the plurality of created sentences are different, wherein
in a case in which the acquisition unit acquires a deletion instruction from the original user as the input data, the processing unit deletes, from the storage unit, the created sentence created by another first user similar to the created sentence created by the original user.

22. The data processing apparatus according to claim 18, wherein the processing unit inputs a prompt including the search query, a viewing history of the created sentence by the second user, and an instruction for inquiring about the search intention to the generation model as the second prompt, and generates a search intention corresponding to the second prompt.

23. The data processing apparatus according to claim 18, wherein
the acquisition unit acquires user information indicating an attribute of the second user as the input data, and
in a case in which an inappropriate key point unsuitable for the attribute of the second user indicated by the user information is included in the list of key points corresponding to the third prompt generated by the processing unit, the output unit outputs a list of key points excluding the inappropriate key point to the electronic apparatus.

24-25. (canceled)

26. A data processing apparatus comprising:
an acquisition unit that acquires input data indicating a user input;
a processing unit that performs specific processing using a generation model that generates information according to the input data; and
an output unit that outputs a result of the specific processing to an electronic apparatus, wherein
the acquisition unit acquires destination information designating a destination and time point information designating a time point as the input data,
the processing unit
inputs a prompt including the destination information and the time point information acquired by the acquisition unit and an instruction for inquiring about an image of the destination at the time point indicated by the destination information and the time point information to the generation model as a first prompt to acquire the image of the destination corresponding to the first prompt, and
inputs a prompt including the destination information, the time point information, and the image of the destination corresponding to the first prompt, and an instruction for generating a moving image of the destination at the time point indicated by the destination information and the time point information to the generation model as a second prompt to generate the moving image of the destination corresponding to the second prompt, and
the output unit outputs the moving image of the destination corresponding to the second prompt generated by the processing unit to the electronic apparatus.

27. The data processing apparatus according to claim 26, wherein
the acquisition unit
acquires a theme of a moving image as the input data, and
the processing unit inputs a prompt including the theme, the destination information, the time point information, the image of the destination corresponding to the first prompt, and an instruction for generating a moving image of the destination at the time point indicated by the destination information and the time point information to the generation model as a second prompt, and generates the moving image of the destination corresponding to the second prompt.

28. The data processing apparatus according to claim 26, wherein
the acquisition unit acquires height information regarding a height of the user as the input data, and
the processing unit generates the moving image of the destination corresponding to the second prompt in accordance with a height of an eye line derived on the basis of the height information.

29. The data processing apparatus according to claim 26, wherein
the acquisition unit acquires the time point information designating a plurality of time points as the input data; and
the processing unit inputs a prompt including the destination information, the time point information, the image of the destination corresponding to the first prompt, and an instruction for generating a moving image of the destination at the time points indicated by the destination information and the time point information to the generation model as a second prompt, and generates the moving image of the destination corresponding to the second prompt in which the plurality of time points indicated by the time point information are arranged in time series.

30. The data processing apparatus according to claim 26, wherein
the acquisition unit acquires a moving speed of a camera at the time of moving and imaging as the input data, and
the processing unit generates a moving image of the destination corresponding to the second prompt and reflecting the moving speed.

31-32. (canceled)
